(19) United States
(12) Patent Application Publication
(10) Pub. No.: US 2014/0365386 A1
(43) Pub. Date: Dec. 11, 2014

(54) Intellectual Property (IP) Analytics System and Method

(71) Applicants: David W. Carstens, Plano, TX (US); Kevin Mark Klughart, Denton, TX (US)

(72) Inventors: David W. Carstens, Plano, TX (US); Kevin Mark Klughart, Denton, TX (US)

(21) Appl. No.: 14/297,260

(22) Filed: Jun. 5, 2014

Related U.S. Application Data
(60) Provisional application No. 61/831,473, filed on Jun. 5, 2013.
(60) Provisional application No. 61/889,604, filed on Oct. 11, 2013.
(60) Provisional application No. 61/930,167, filed on Jan. 22, 2014.

(51) Int. Cl. G06Q 50/18; G06Q 10/10

(52) U.S. Cl. CPC G06Q 50/184; G06Q 10/10
USPC 705/310

(57) ABSTRACT

An Intellectual Property (IP) Analytics system/method supporting the rapid analysis of data associated with patents, copyrights, and/or trademarks is disclosed. The system incorporates a graphical user interface (GUI) in conjunction with an IP analytics web server (IAS) to permit user queries regarding IP information to be defined as a graphically interconnected network (GIN) of information flows connecting defined IP data sources, processing functions, and report generation modules. The GIN may be arbitrarily configured based on IP query context to optimize retrieval of information associated with tasks commonly performed in support of IP procurement, maintenance, and defense operations. The system permits a variety of IP query application contexts to be supported, including prosecution, litigation, valuation, licensing, competitive analysis, and commercial research/development. Support for synchronous and asynchronous data analysis is supported with provisions for application programming interfaces (APIs) to IP databases not maintained by the IAS.

### CROSS REFERENCE TO RELATED APPLICATIONS

### U.S. Provisional Patent Applications

This application claims benefit under 35 U.S.C. §119 and incorporates by reference U.S. Provisional Patent Application for IP ANALYTICS SYSTEM AND METHOD by inventors David W. Carstens and Kevin Mark Klughart, filed electronically with the USPTO on Jun. 5, 2013, with Ser. No. 61/831,473, EFS ID 15961102, confirmation number 8693, docket ADCAR.0101P.

This application claims benefit under 35 U.S.C. §119 and incorporates by reference U.S. Provisional Patent Application for INTELLECTUAL PROPERTY (IP) ANALYTICS SYSTEM AND METHOD by inventors David W. Carstens and Kevin Mark Klughart, filed electronically with the USPTO on Oct. 11, 2013, with Ser. No. 61/889,604, EFS ID 17103227, confirmation number 8649, docket ADCAR.0101P2.

This application claims benefit under 35 U.S.C. §119 and incorporates by reference U.S. Provisional Patent Application for INTELLECTUAL PROPERTY (IP) ANALYTICS SYSTEM AND METHOD by inventors David W. Carstens and Kevin Mark Klughart, filed electronically with the USPTO on Jan. 22, 2014, with Ser. No. 61/930,167, EFS ID 17992349, confirmation number 2336, docket ADCAR.0101P3.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to systems and methods for Intellectual Property (IP) analytics. Specifically, the present invention in many preferred embodiments has application to situations in which Intellectual Property (IP) Analytics must be performed on large databases comprising patents, copyrights, and/or trademarks in support of patent prosecution, litigation, valuation, and/or IP licensing efforts. In many of these circumstances the information to be analyzed must be gathered from a wide variety of incompatible data sources and coordinated for display based on parameters that are not associated with the individual data sources.

### PRIOR ART AND BACKGROUND OF THE INVENTION

### Background

The topic of Intellectual Property (IP) Analytics involves a wide variety of analysis functions that are currently performed largely by manual effort. Several examples of these analysis tasks include the following:
Searching patent databases to find patents owned by a particular company or individual.
Generating patent infringement reports that include patent searches spanning a number of classes/subclasses, and integrating this information (both textual and graphic) into appropriately formatted client reports.
Generating claims charts for individual patents and mapping this claims information to other patents and/or potentially infringing products.
Searching for relevant prior art when filing new patent applications.
Searching for anticipatory prior art when defending a patent during litigation.
Analyzing the patent prosecution history of an issued patent.
Determining metrics associated with research and development of a competitor company in particular areas of technology.
Analyzing industry trends in particular technology fields.
Analyzing patent portfolios to estimate their worth for licensing or business merger purposes.
Analyzing particular USPTO Patent Examiners/Art Units and their claims allowance statistics.
Analyzing the importance of a particular patent in terms of other patents that cite it as prior art.
   Those skilled in the art will recognize that this list is non-exhaustive and only exemplary of the types of analysis that IP professionals are tasked to perform on a daily basis.

### Hurdles to Efficient Productivity

To date, a significant problem in the IP analytics industry is the lack of a tool that can properly analyze IP data stored in a wide variety of IP databases that are currently available to the public. While some inroads have been made recently in which the USPTO has provided full-text searchable databases and also provided raw patent data for distribution to the public through private sources such as GOOGLE®, the mere availability of the data does not mean that it can be efficiently analyzed and manipulated in a way that relieves IP professionals from the burden of significant manual (and error prone) analysis.

Attempts at providing BOOLEAN search functionality or keyword database searching functionality have proven ineffective in solving this problem, as the types of data analysis promoted by canned or scripted user interfaces is not flexible enough to anticipate the wide variety of analysis types required by the breadth of IP professionals. Furthermore, since the information in IP databases is dynamically expanding (and may include information collected on a worldwide basis), repeated queries using conventional database techniques are not sufficiently efficient to address IP analytics tasks that must be performed on a regularly scheduled basis.

For example, the request for a weekly report detailing the status of competitor patent applications and issued patents in a given class/subclass must not only consider the issued patent database, the published patent application database, but also changes in assignment documents that are filed with the patent office, as patents (and patent applications) may be assigned apart from the patent application process. As can be seen from this simple example, such a simple query may result in a level of analysis that might take weeks to complete if performed manually. It is very typical in these scenarios that due to the breadth and complexity of the analysis task that something is missed and the resulting report is inaccurate or fatally flawed in failing to provide all of the relevant information.

### Deficiencies in the Prior Art

The prior art as detailed above suffers from the following deficiencies:
Prior art Intellectual Property (IP) Analytics systems fail to integrate all available IP data when analyzing an IP query.
Prior art Intellectual Property (IP) Analytics systems do not allow integration of disparate IP datasets when performing an IP analysis.
Prior art Intellectual Property (IP) Analytics systems are not reconfigurable to accommodate new datasets.
Prior art Intellectual Property (IP) Analytics systems do not have the capability of repeatedly inspecting IP databases to produce periodic reports.
Prior art Intellectual Property (IP) Analytics systems do not have the capability of asynchronously generating reports based on updates to IP databases.
Prior art Intellectual Property (IP) Analytics systems do not have templates tailored to specific activities commonly performed by IP practitioners.
Prior art Intellectual Property (IP) Analytics systems do not provide tools to increase productivity of IP practitioners when performing common IP analysis tasks.

While some of the prior art may teach some solutions to several of these problems, the core issue of integrating all aspects of relevant data into an Intellectual Property (IP) Analytics system has not been solved by the prior art.

### OBJECTIVES OF THE INVENTION

Accordingly, the objectives of the present invention are (among others) to circumvent the deficiencies in the prior art and affect the following objectives in the context of an Intellectual Property (IP) Analytics system and method:
(1) Provide for an Intellectual Property (IP) Analytics system and method that permits integration of all available IP data when analyzing an IP query.
(2) Provide for an Intellectual Property (IP) Analytics system and method that permits integration of disparate IP datasets when performing an IP analysis.
(3) Provide for an Intellectual Property (IP) Analytics system and method that permits the system to be reconfigurable to accommodate new datasets.
(4) Provide for an Intellectual Property (IP) Analytics system and method that permits the capability of repeatedly inspecting IP databases to produce periodic reports.
(5) Provide for an Intellectual Property (IP) Analytics system and method that permits the capability of asynchronously generating reports based on updates to IP databases.
(6) Provide for an Intellectual Property (IP) Analytics system and method that permits creation of templates tailored to specific activities commonly performed by IP practitioners.
(7) Provide for an Intellectual Property (IP) Analytics system and method that permits access to tools to increase productivity of IP practitioners when performing common IP analysis tasks.
(8) Provide for an Intellectual Property (IP) Analytics system and method that permits rapid graphical analysis output of various IP metrics.
(9) Provide for an Intellectual Property (IP) Analytics system and method that permits document templates to be automatically updated based on the results of an IP query.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention as embodied in a system and method permits user queries regarding IP information to be defined using a graphical user interface (GUI) operating on a computer system executing instructions from a computer readable medium. The GUI permits a graphically interconnected network (GIN) of information data flows to be defined using IP data sources, processing functions, and report generation modules. The GIN representation of the IP query is then used to trigger synchronous and/or asynchronous activity on an IP analytics web server (IAS) tasked with interpreting the GIN query to produce graphical and/or hardcopy reports based on information retrieved from IP databases and then manipulated using the filters and analysis functions defined within the GIN.

Each IP data source defined within this context may have associated with it key index search criterion and may be configured in some circumstances as an intermediate data file that is generated by one or more previous GIN queries. The incorporation of processing functions including BOOLEAN search operators, repetitive execution functionality, comparison functions between IP data sources, cross-linked data references, parent-child history trees, web-crawling features, and OCR functionality are anticipated within this context. Reporting functions in this context are anticipated to include support for integration of graphical and/or textual information retrieved or extracted from IP databases into formal reporting formats employing optional embedded objects that may be dynamically updated based on repetitive execution functions.

Within this context a variety of canned GIN configurations may be provided to support IP analytics in fields such as patent preparation, patent prosecution, IP litigation, IP valuation, IP licensing, competitive IP analysis, and the like.

### BRIEF DESCRIPTION OF THE DRAWINGS

For a fuller understanding of the advantages provided by the invention, reference should be made to the following detailed description together with the accompanying drawings wherein:

FIG. 1 illustrates a block overview diagram describing a presently preferred system embodiment of the present invention;

FIG. 2 illustrates a flowchart describing a presently preferred method embodiment of the present invention;

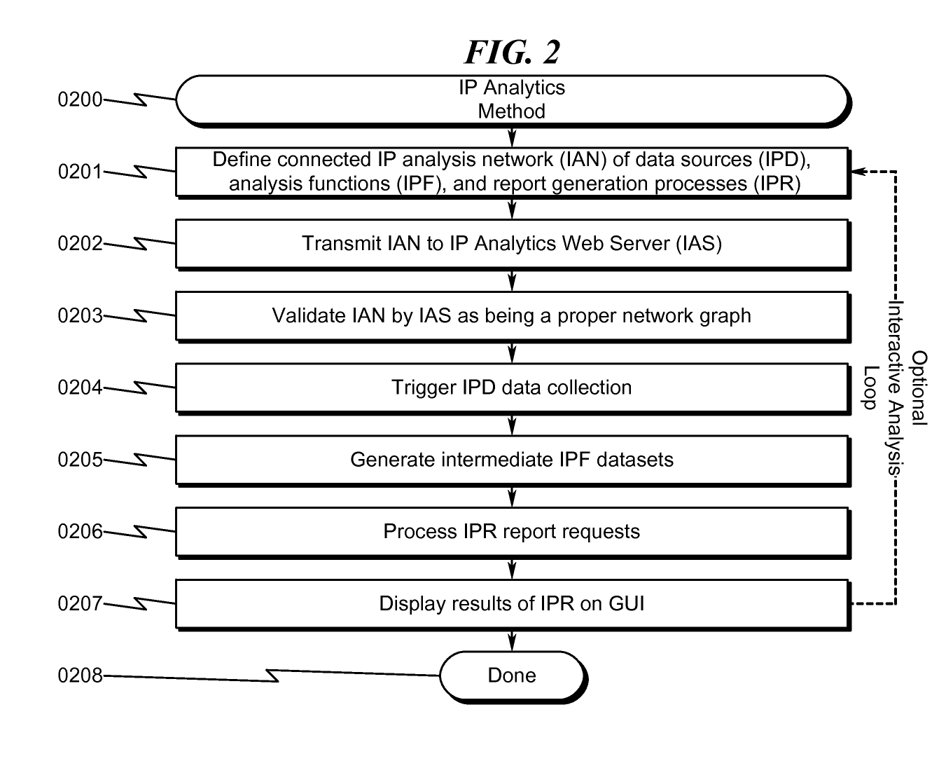

FIG. 3 illustrates an exemplary mapping between IANs generated using a GUI editor and an abstracted user interface display supporting simplified user query data entry;

FIG. 4 illustrates an exemplary IAN graphic editor in which IAN nodes are selected from a menu and interconnected to represent a source/analysis/display processing stream;

FIG. 5 illustrates an exemplary abstracted user interface in which IAN is constructed using a graphical user interface in which IAN templates are selected for processing a particular user IP query request;

FIG. 6 illustrates an exemplary list of IP databases that may be used in some preferred invention embodiments;

FIG. 7 illustrates an exemplary list of IP analytics functions (IPF) that may be utilized with some preferred invention embodiments;

FIG. 8 illustrates an exemplary list of IP class-specific keyed search criterion that may be utilized with some preferred invention embodiments;

FIG. 9 illustrates a general process flow associated with a preferred invention embodiment;

FIG. 10 illustrates an exemplary data collection methodology useful in a preferred invention embodiment;

FIG. 11 illustrates an estimated storage profile associated with a preferred invention embodiment;

FIG. 12 illustrates an exemplary report generation process associated with a preferred invention embodiment;

FIG. 13 illustrates several key database creation modules associated with preferred invention embodiment;

FIG. 14 illustrates a typical report analytics graph (applications most cited in rejections by class/subclass) associated with preferred invention embodiment;

FIG. 15 illustrates a typical report analytics graph (worldwide patent activity vs. technology) associated with preferred invention embodiment;

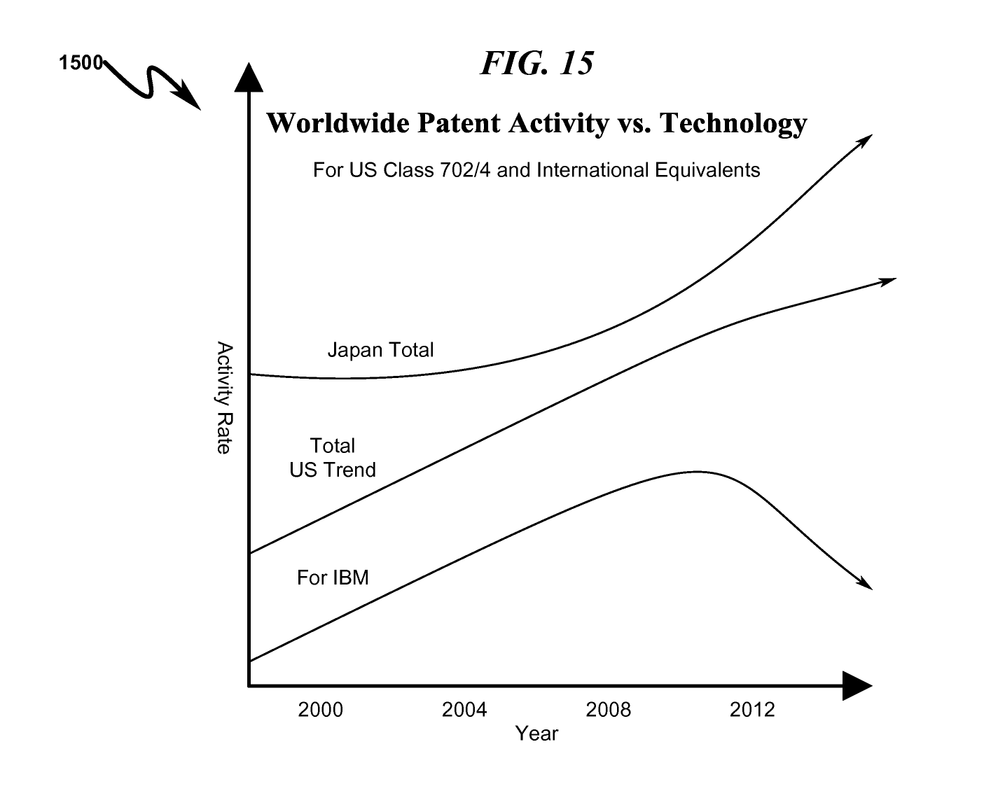

FIG. 16 illustrates a typical report analytics graph (portfolio analysis vs. time by company) associated with preferred invention embodiment;

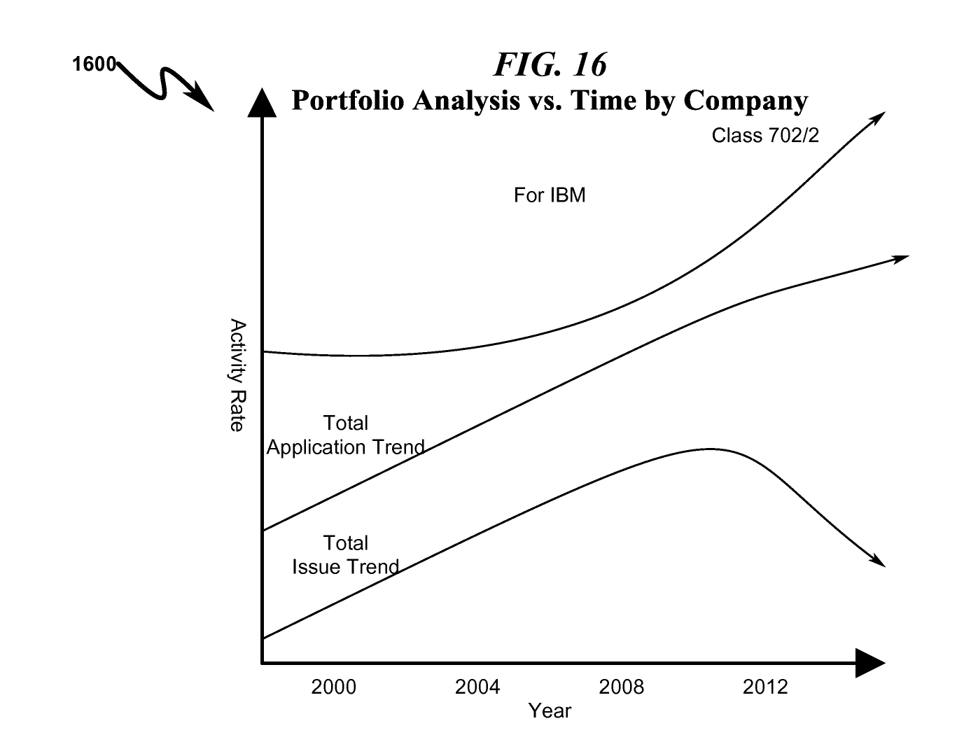

FIG. 17 illustrates a typical report analytics graph (pendency vs. time for specific class/subclasses) associated with preferred invention embodiment;

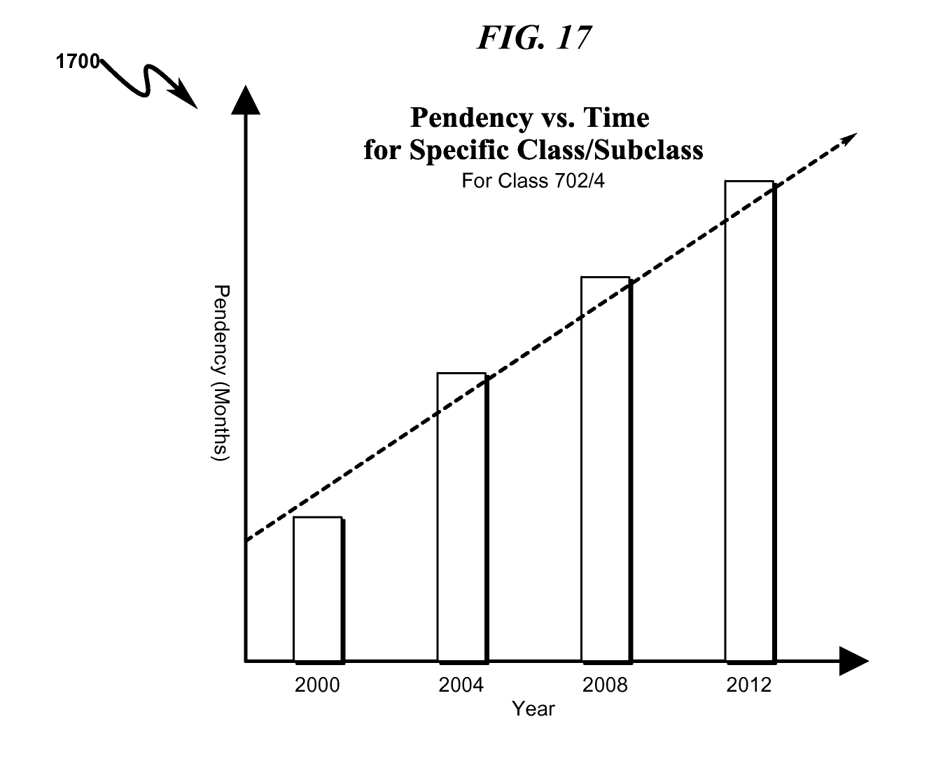

FIG. 18 illustrates a typical report analytics graph (allowance rate vs. time by specific class/subclass) associated with preferred invention embodiment;

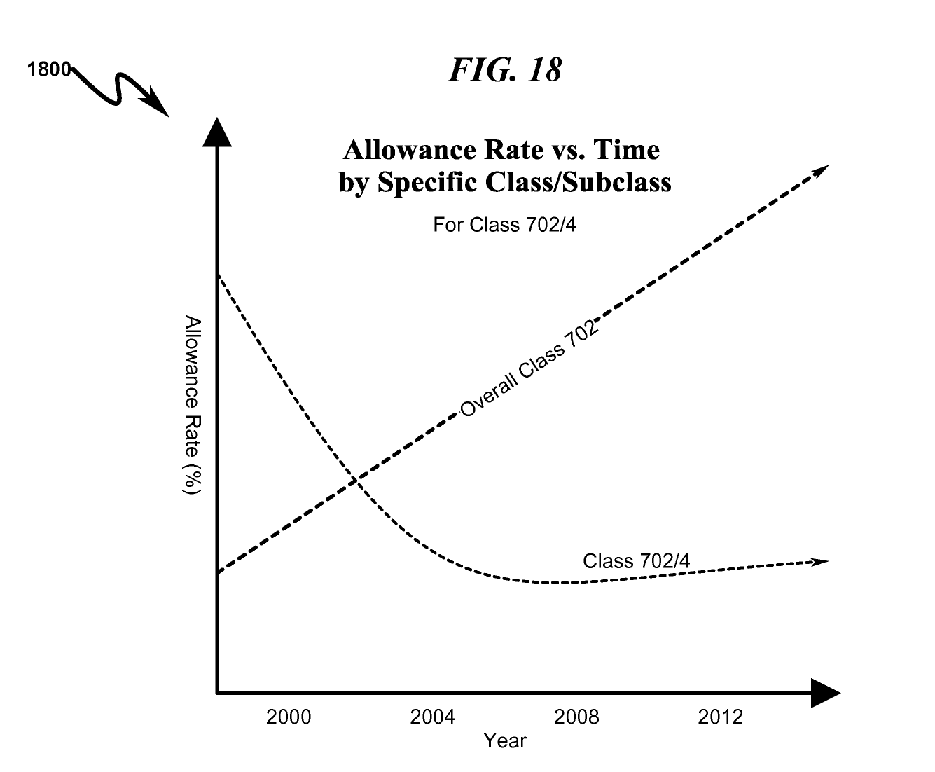

FIG. 19 illustrates a typical report analytics graph (allowance rate vs. time by examiner) associated with preferred invention embodiment;

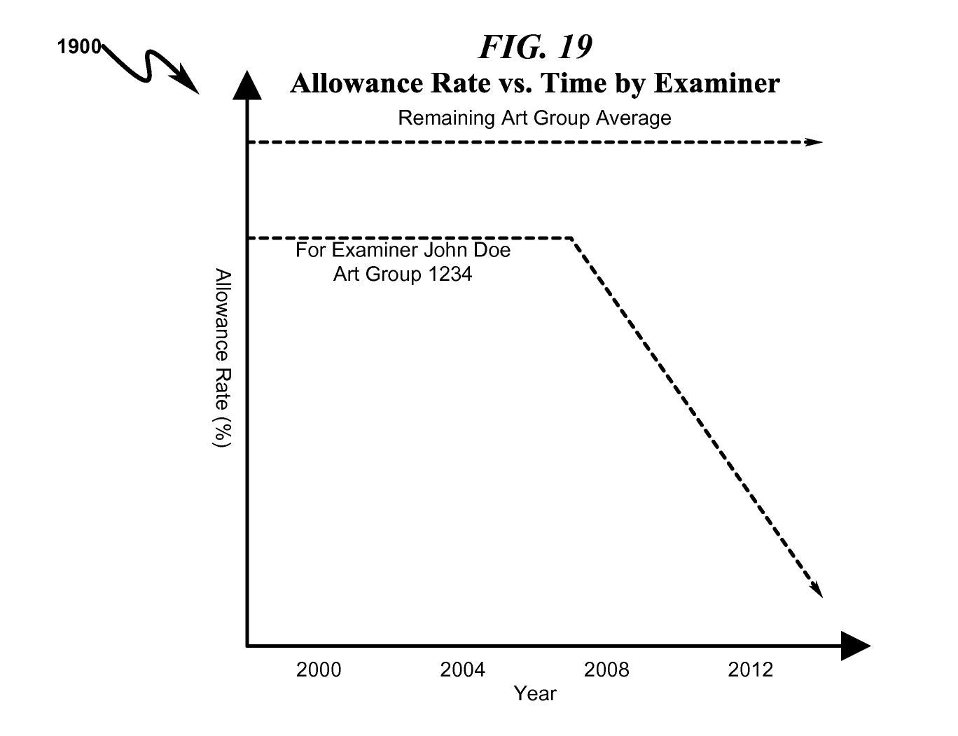

FIG. 20 illustrates a typical report analytics graph (patent class activity vs. time by specific class/subclass) associated with preferred invention embodiment;

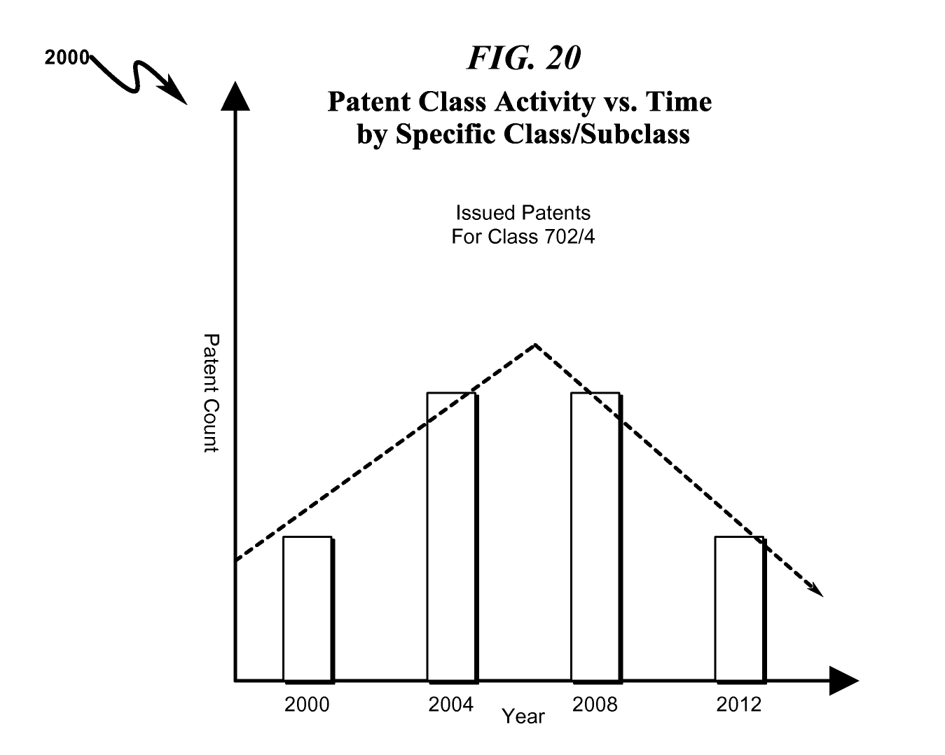

FIG. 21 illustrates a typical report analytics graph (citation rate vs. time by specific patent) associated with preferred invention embodiment;

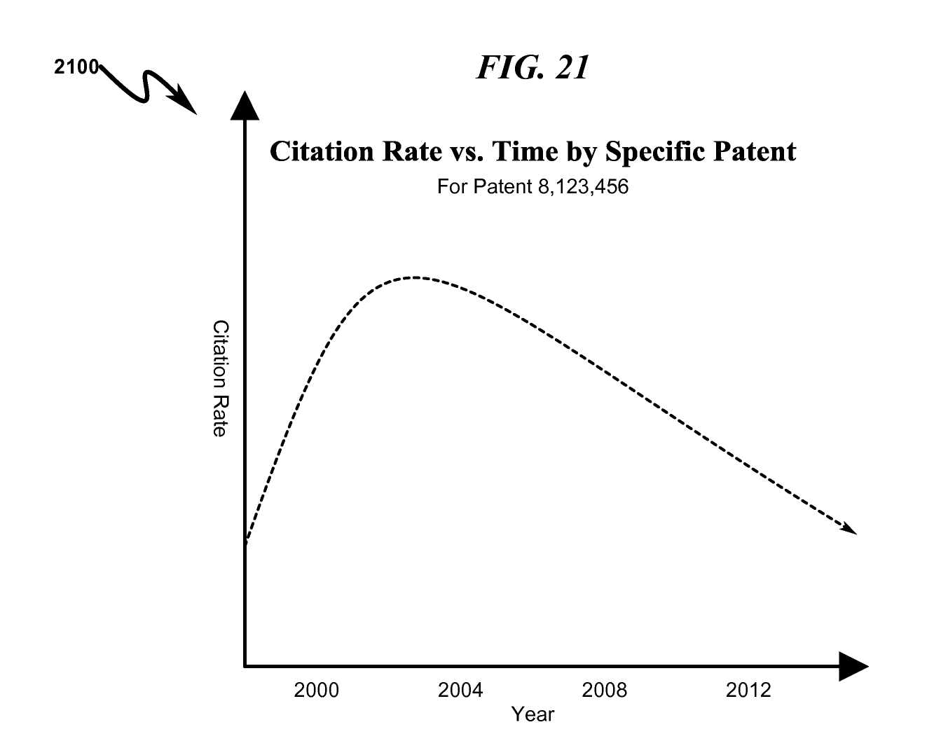

FIG. 22 illustrates a typical report analytics graph (citation rate vs. time by company) associated with preferred invention embodiment;

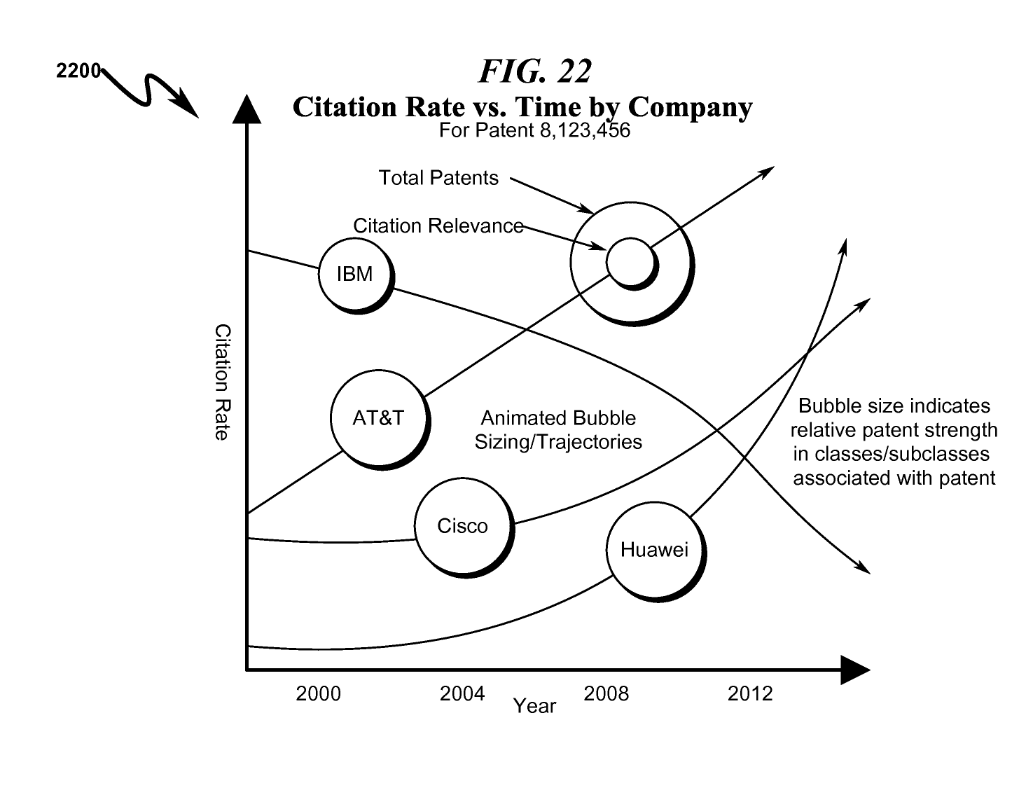

FIG. 23 illustrates a typical report analytics graph (class/subclass activity vs. time by company) associated with preferred invention embodiment;

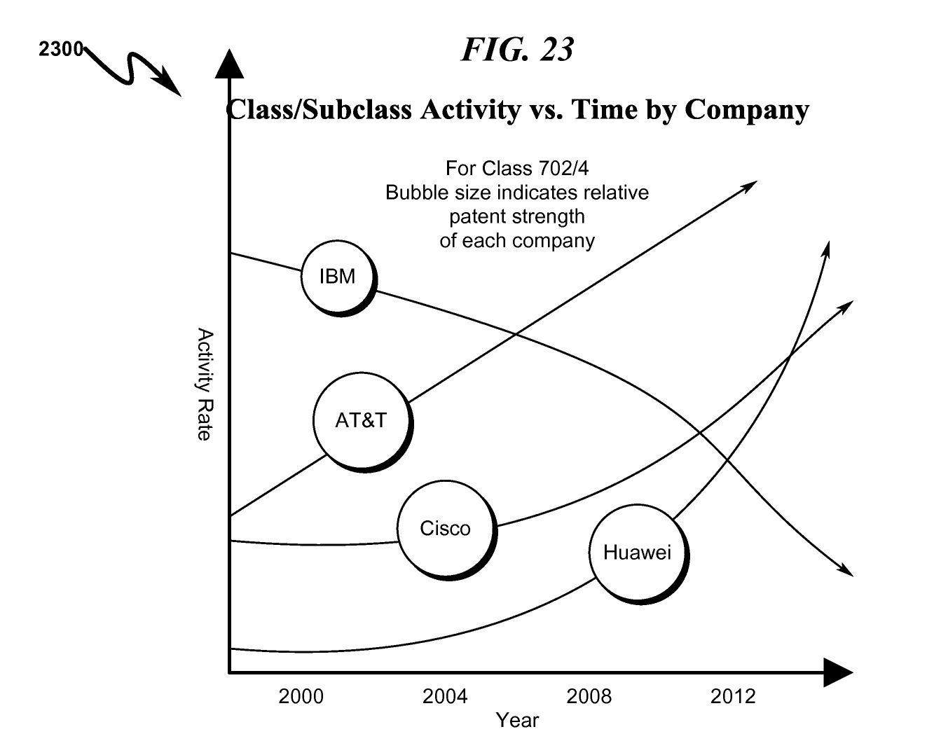

FIG. 24 illustrates a typical report analytics graph (patent activity vs. time by company) associated with preferred invention embodiment;

FIG. 25 illustrates an exemplary patent search query method;

FIG. 26 illustrates an exemplary patent search IAN graphical network;

FIG. 27 illustrates an exemplary patent validity query method;

FIG. 28 illustrates an exemplary patent validity IAN graphical network;

FIG. 29 illustrates an exemplary provisional patent priority analysis query method;

FIG. 30 illustrates an exemplary provisional patent priority analysis IAN graphical network;

FIG. 31 illustrates an exemplary patent prosecution query method;

FIG. 32 illustrates an exemplary patent prosecution IAN graphical network;

FIG. 33 illustrates an exemplary art group analytics query method;

FIG. 34 illustrates an exemplary art group analytics IAN graphical network;

FIG. 35 illustrates an exemplary litigation search method;

FIG. 36 illustrates an exemplary litigation search IAN graphical network;

FIG. 37 illustrates an exemplary patent/portfolio valuation query method;

FIG. 38 illustrates an exemplary patent/portfolio valuation IAN graphical network;

FIG. 39 illustrates a system block diagram depicting an exemplary embodiment of a coherent automated database extraction system useful in some preferred invention embodiments;

FIG. 40 illustrates a flowchart depicting an exemplary embodiment of a coherent automated database extraction method useful in some preferred invention embodiments;

FIG. 41 illustrates an exemplary free-form user query when searching a patent database;

FIG. 42 illustrates an exemplary free-form user query when searching a patent database that is integrated with class/subclass technology suggestions;

FIG. 43 illustrates an exemplary technology class/subclass patent dictionary creation system;

FIG. 44 illustrates an exemplary technology class/subclass patent dictionary creation method;

FIG. 45 illustrates an exemplary search results display depicting tabbed patent/document access;

FIG. 46 illustrates an exemplary search results display depicting hyperlinked patent/document access;

FIG. 47 illustrates an exemplary document display integrating hypertext links to other search results options;

FIG. 48 illustrates an exemplary document display integrating hypertext links to a patent tree class/subclass.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiments of the invention with the understanding that the present disclosure is to be considered as an exemplification of the principles of the invention and is not intended to limit the broad aspect of the invention to the embodiments illustrated.

The numerous innovative teachings of the present application will be described with particular reference to the presently preferred embodiments, wherein these innovative teachings are advantageously applied to the particular problems of an INTELLECTUAL PROPERTY (IP) ANALYTICS SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### System Overview (0100)

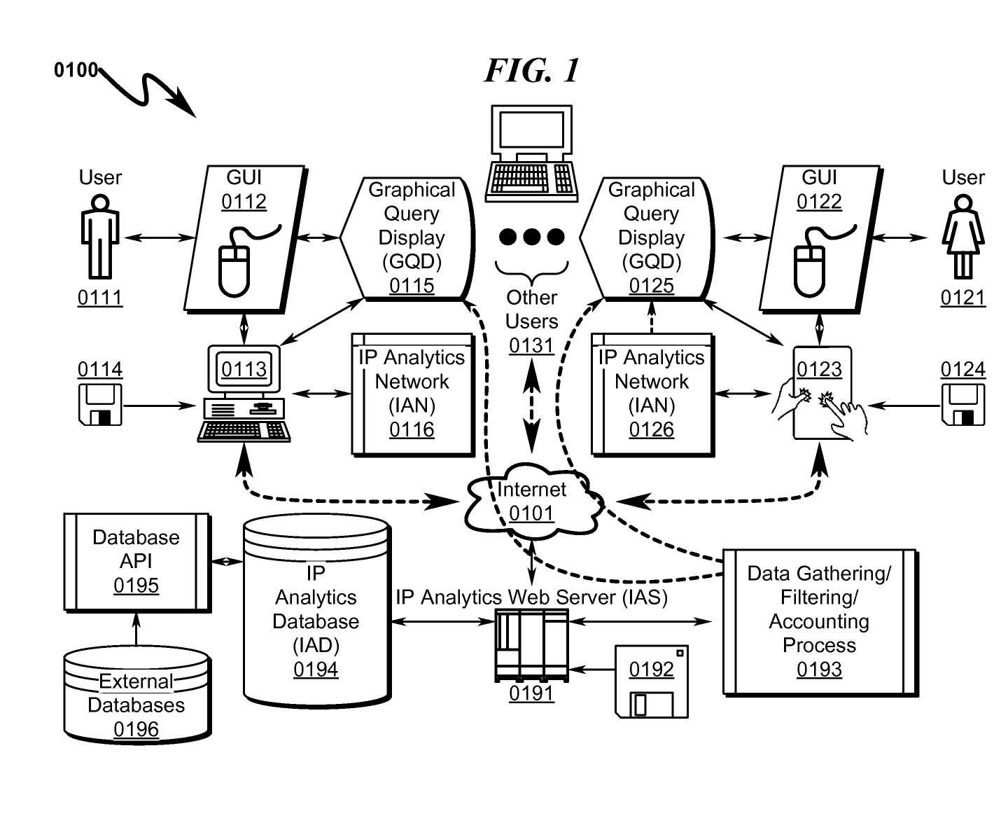

The present invention in various embodiments addresses one or more of the above objectives in the following manner. As generally depicted in FIG. 1 (0100), an exemplary invention system embodiment is configured to permit a number of users (0111, 0121, 0131) to interact with a graphical user interface (GUI) (0112, 0122) operating under control of a computer system (0113, 0123) executing software read from computer readable media (0114, 0124). Within this context graphical query displays (GQD) (0115, 0125) are presented on the GUIs (0112, 0122) that allow the users (0111, 0121, 0131) to define an IP analytics query to be generated that may span a wide range of IP data sources. Associated with each IP analytics query is an IP analytics network (IAN) (0116, 0126) that represents a graphical representation of the IP data sources (IPD) to be analyzed, IP processing functions (IPF) to be performed, and IP report generation processes (IPR) to be activated on completion of the analysis. These IANs (0116, 0126) may be constructed as planar network graphs, but need not be so configured in many complex query IAN configurations. Furthermore, IPF functions may incorporate periodic or event-driven IPR features that may form the basis of a wide variety of IP analytics processes that are often impossible to perform accurately and timely on a manual basis due to the breadth and depth of the information that must be analyzed and cross-matched.

The IANs (0116, 0126) generated by the user (0111, 0121, 0131) GUIs (0112, 0122) via the GQDs (0115, 0125) are communicated to an IP analytics web server (IAS) (0191) over the Internet (0101). The IAS (0191) hosts a website responsible for managing the GQDs (0115, 0125) and is configured to execute machine instructions implementing the website from a computer readable medium (0192). Within this context a data gathering/filtering/accounting process (0193) is executed under control of the IAS to gather data from one or more IP analytics databases (IAD) (0194) as defined by the IPD, apply the IPF processing, and generate reports based on the IPR specification. The overall control of this process on the IAS (0191) is driven by the network defined by the IANs (0116, 0126). As such, the IAS (0191) may be configured to fracture the analysis functions within the IANs (0116, 0126) across multiple computing servers and collect the resulting analysis for presentation on the GUIs (0112, 0122) as directed by the IPRs.

As indicated in FIG. 1 (0100), within this context the IAD (0194) may be accessed by an application programming interface (API) (0195) operating to periodically update the IAD (0194) with the content of one or more external databases (0196) or content from government or third-party websites.

### Method Overview (0200)

The present invention system may be utilized in the context of an overall Intellectual Property (IP) Analytics method, wherein the Intellectual Property (IP) Analytics system described previously is controlled by a method having the following steps:
(1) Graphically defining a connected IP analysis network (IAN) of IP data sources (IPD), IP analysis functions (IPF), and IP report generation processes (IPR) using a graphical user interface (GUI) (0201);
(2) Transmitting the IAN to an IP analytics web server (IAS) (0202);
(3) Validating the IAN with the IAS to ensure that the IAN is a properly configured network graph (0203);
(4) Triggering IPD data collection by the IAS from one or more IP analytics databases (IAD) (0204);
(5) Generating intermediate IPF datasets based on execution of the IAN network by the IAS (0205);
(6) Processing IPR report requests by the IAS (0206); and
(7) Displaying results of the IPR processing on the GUI (0207), with optional interactive looping to step (1).

Integration of this and other preferred exemplary embodiment methods in conjunction with a variety of preferred exemplary embodiment systems described herein is anticipated by the overall scope of the present invention.

### Graphical Abstraction Layers (0300)

Referencing FIG. 1 (0100), within the context of the GQDs (0115, 0125) an abstraction layer may be formed in some preferred embodiments that permits the IANs (0116, 0126) to be represented as a connected visual graph on the GUIs (0112, 0122) using pulldown icons representing the IPD, IPF, and IPR elements of the IANs (0116, 0126) and interconnection links (lines) representing data flows between the entities.

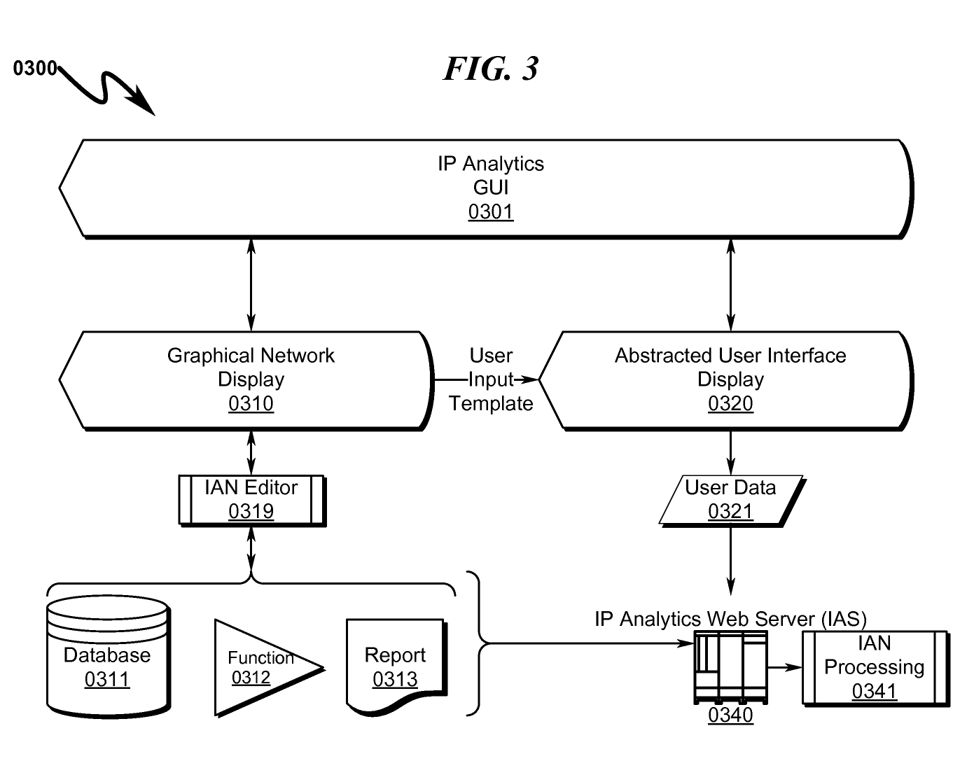

This invention concept is depicted in more detail in FIG. 3 (0300) wherein a graphical network display (0310) that is used to edit the graphically represented IAN using icons representing databases (0311), functions (0312), and reports (0313) may be used as a user input template to form a high level data entry user interface (0320) that collects user data inputs (0321) to the IAN from a user computer interface. This high level abstracted user interface (0320) need not have knowledge of the particular data flows depicted in the IAN, but may only have a few dialog entry boxes that provide important information associated with the query request.

Once the user data input (0321) is completed, the IAN and user data (0321) are sent to the IP analytics web server (0340) for validation and processing (0341) of the user query request. In this fashion, a user may select from a number of user templates (that may be canned or customized) to produce reports or other documents that are either commonly required from IP professionals or which may be customized for a particular IP query task.

### IAN Generation Via Graphical Network (0400)

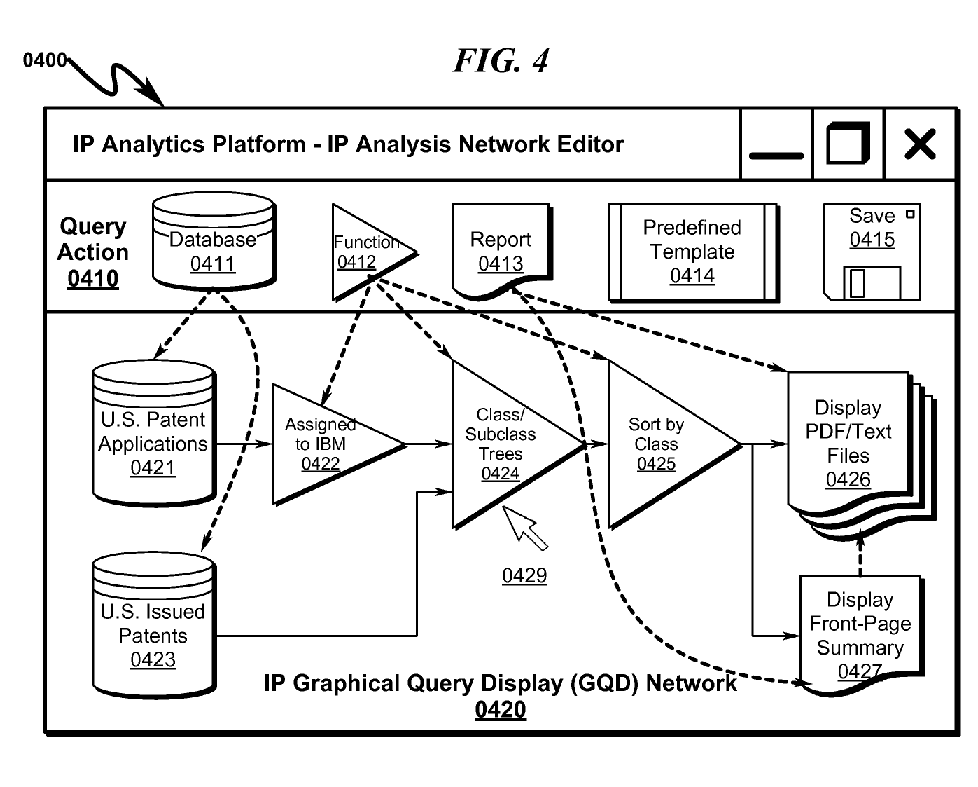

The present invention anticipates that the IAN used to form the basis of an IP query is generated at a primitive level using a graphical user interface (GUI) network editor as exemplified by the sample screen depicted in FIG. 4 (0400). Here a series of query action icons (0410) typically comprising database selection (0411), function selection (0412), and report generation (0413) are used to define data, processing, and output functions to be considered as an overall query. These query actions (0410) are selected with a cursor (0429) and placed within the IP Graphical Query Display (GQD) Network area of the screen and interconnected with lines to form the IAN that graphically depicts the IP query to be performed.

In the example depicted in FIG. 4 (0400), it can be seen that the query can involve complex analysis functions. Here the example query first utilizes U.S. Patent Applications (published) (0421) and determines which are assigned to IBM in a filtering function (0422). The result of this query is then used as a list of class/subclass identifiers and matched against U.S. Issued Patents (0424) using a class/subclass tree matching function (0424). Thus, the functions (0412) provided in the action query menu (0410) can involve complex analyses having one or more data inputs. Here the class/subclass tree matching function (0424) determines the classes/subclasses from one input and then uses this as a filtering function to extract records from the U.S. issued patent database (0423). The result of this matching function is then sorted by class (0425) in another function and displayed in a series of reports (0426) representing the graphics/text associated with each of the matching patents. For example, the report generated (0426) may include launching a PDF viewer having a tab associated with each matching patent sorted by class and subsequent invocations of a MICROSOFT® WORD® document viewer with tabs corresponding to the OCR of each matching patent. Additionally, a singular PDF report file (0427) containing the front page of each patent is generated for rapid viewing of the search results. This would allow rapid perusal of each matching patent matching the IP query. The use of embedded hyperlinks within this summary file may in some cases be implemented to permit traversal from the summary report file (0427) to the individual PDF/text report detail files (0426). This particular example would typically represent hours of work using conventional patent database searches that are provided by the prior art. The integration of organized PDF displays (0426) and summary sheets (0427) greatly simplifies the tasks associated with generating reports associated with the automated searching function.

Within this GQD editor the ability to save predefined templates (0414) and query action networks (0415) is anticipated. The predefined templates (0414) may in some circumstances be configured to provide subfunction capability wherein certain query processing functions that are relatively complex may be abstracted to a higher level and used by other IP queries as a separate data source, function block, and/or reporting engine.

### Template-Based Topical Queries (0500)

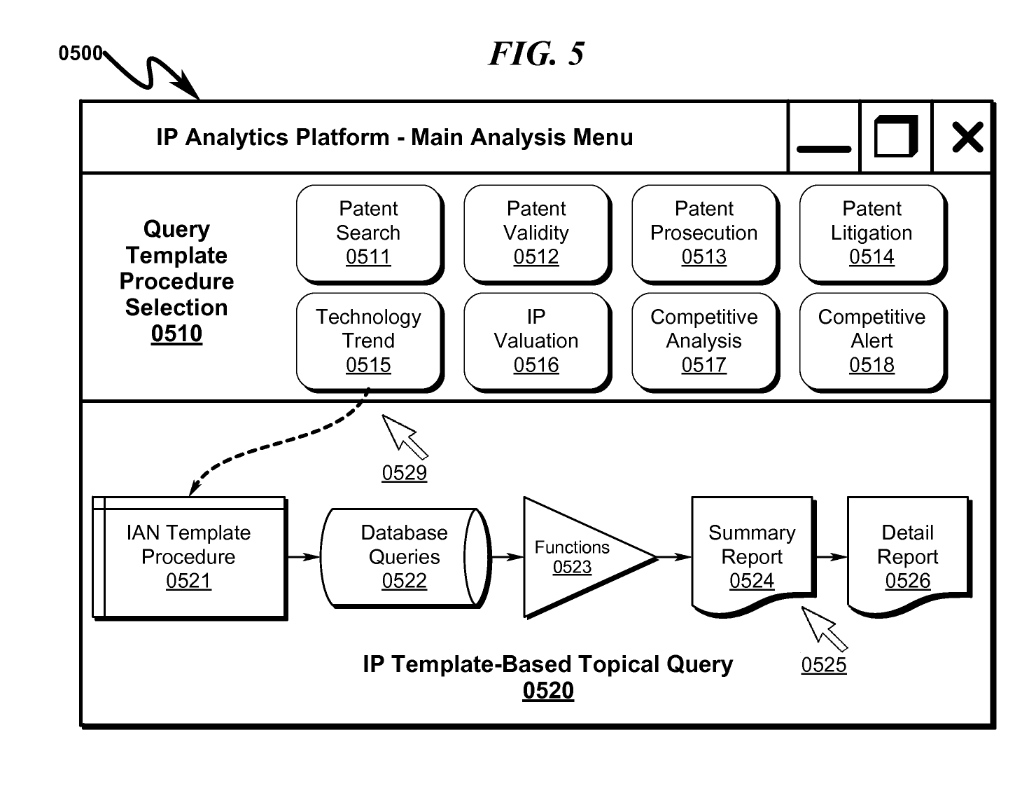

As generally illustrated in FIG. 5 (0500), the predefined templates (0414) that may be saved in the exemplary graphical editor depicted in FIG. 4 (0400) may be presented to via an abstracted user interface as depicted in FIG. 5 (0500) in which a number of query procedures (0510) may be represented as menu dialog buttons (0511, 0512, 0513, 0514, 0515, 0516, 0517, 0518) that are invoked via mouse selection (0529) to activate the associated IAN template procedure (0521) incorporating the IAN comprising database queries (0522), analysis functions (0523), and summary reports (0524). Within this context the generated summary reports (0524) may be hyperlinked to enable selection (0525) of individual report entities to generate detailed reports (0526).

### Exemplary IP Database Sources (0600)

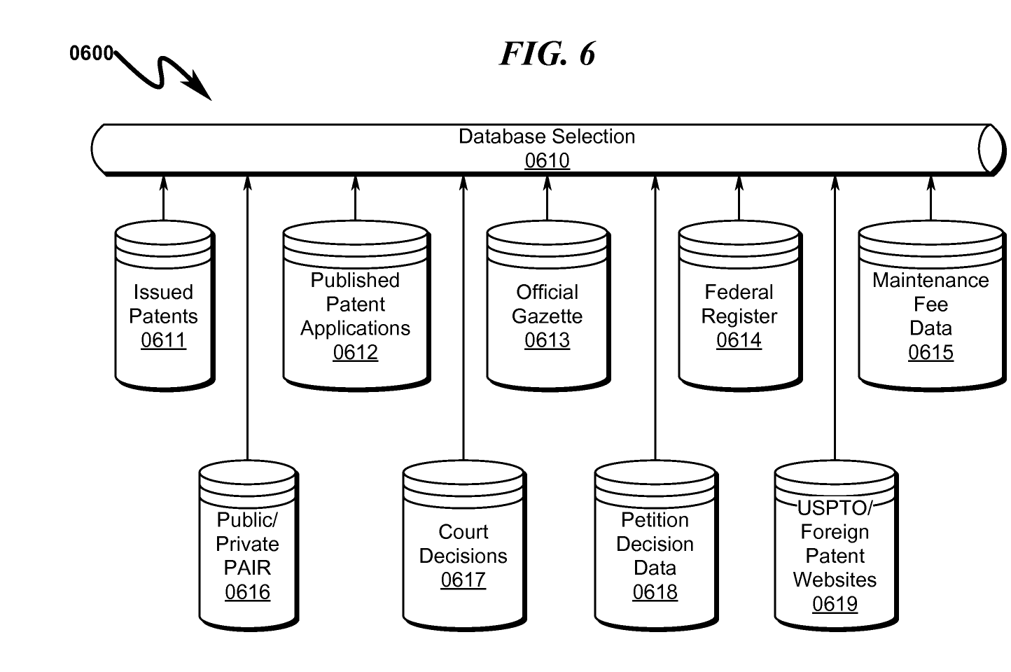

While the present invention anticipates that a wide variety of IP data sources (IPD) may be utilized to construct the IP analytics platform (including patent, trademark, and copyright databases), several exemplary database sources (0610) are illustrated in FIG. 6 (0600), and may include the following:
Issued patents (U.S. and foreign) (0611);
Published patent applications (U.S. and foreign) (0612);
Official Gazette publications (0613);
Federal Register publications (0614);
Maintenance fee statistics (0615);
Public/Private Patent Application Information Retrieval (PAIR) data (including patent application file wrappers) (0616);
Court decisions (0617);
Petition decisions (0618);
USPTO and foreign patent office websites and published documents (0619).
   One skilled in the art will recognize that this exemplary list is non-exhaustive and may also be applied in similar fashion to other forms of IP such as copyrights and trademarks without loss of generality.

Any of these sources may incorporate graphics files that by their very nature do not provide for text-searching capabilities. For this reason, the present invention anticipates that many of the databases that incorporate images will also have associated indexed text files that have been scanned using optical character recognition (OCR) technology to provide for data associations between various files of like content. This multi-mapping of data using OCR scanning permits a given data stream to be manipulated and searched in a variety of ways not possible with image-only data manipulation. This is especially true of image intensive data associated with patent drawings and the like.

### Exemplary IP Functions (0700)

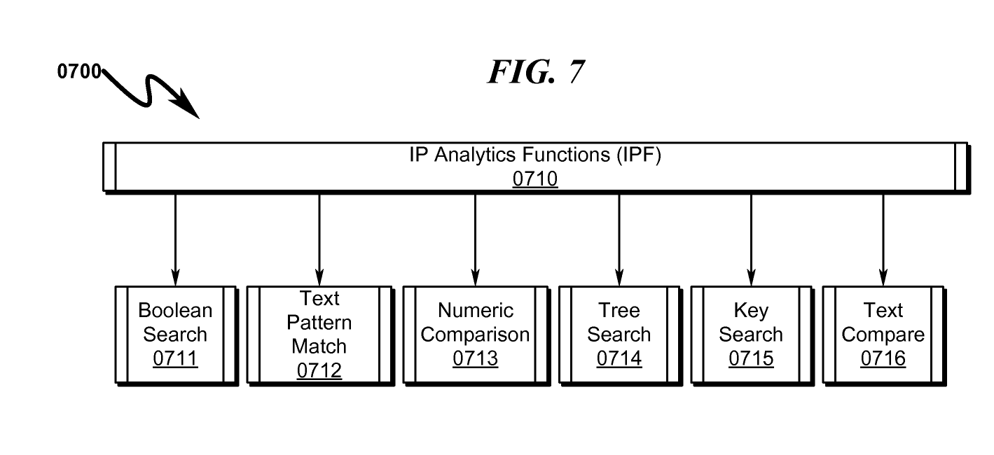

The present invention anticipates that a wide variety of IP analysis functions (IPF) may be utilized within the IAN description of a typical IP analytics query. Several of these are generally illustrated in the function map depicted in FIG. 7 (0700). These functions may include but are not limited to the following:
BOOLEAN Search (0711). This can provide a traditional BOOLEAN search function such as “INVENTOR=SMITH & ASSIGNEE=IBM & ˜CLASS=123” that incorporate unitary and binary BOOLEAN operators/functions.
Text Pattern Matching (0712). This may comprise a text pattern search function incorporating wildcard regular expressions including single (“?”) and multiple (“*”) characters. Examples of this might include “*cycle” matching “bicycle”/“tricycle”/“motorcycle” as well as “??cycle” matching only “bicycle.” Note that these text pattern matches can be incorporated within the BOOLEAN searches listed above.
Numeric Comparison (0713). This may comprise numeric relations that may incorporate a wide variety of data types. For example, date searching such as “20130501<date<=31-DEC-2013” or “issued patents>10” or “examiner rejections>4.” As can be seen from this example the data types associated with this numeric comparison can vary widely based on the search context.
Tree Search (0714). This function generates a tree from given data sources based on a key. For example, selection of U.S. Pat. No. “7,654,321” as a data source with search keys of “class/subclass” will generate a tree search criterion containing all classes/subclasses for the selected patent. This information may then be used as the search criterion for another search, such as a search into patent application databases for recently published applications in these particular technology areas. Similarly, it is possible to perform searches for inventor lists, prior art references, cited references, and other information contained in a given search document that can form the basis of a more comprehensive tree search. Note that this information can cross database boundaries and permit cross-linking to other data sources such as technical publications, foreign patent publications, etc. A number of IP class specific context searches may be defined in this context. For example, a patent class context search would allow a class/subclass to reference all associated patents and the classes/subclasses referenced therein. Furthermore, the patent class context search could permit a patent number to automatically include all associated patent class/subclasses and the patents referenced thereby. This is an extremely powerful search tool that can drastically reduce the number of search operations (and associated errors) that may be associated with traditional manual search techniques.
Keyed Searches (0715). This may comprise a search function that retrieves data from an IP source using a particular key, such as “inventor” or “assignee.” Note that the present invention anticipates that user-defined keys may be generated to allow complex data filtering and function operation to generate intermediate datasets that are then used as sources for other operations.
File Comparison (0716). This may comprise a text comparison function to determine the differences between two text or image files. Applications for this include comparison of the content of Provisional Patent Applications against later filed Utility Patent Applications as well as comparison of patent claims during the prosecution history of a patent application.
   One skilled in the art will recognize that this list is non-exhaustive and only illustrative of the types of analytic functions that may be incorporated within the present invention.

### Exemplary IP-Class Specific Searches (0800)

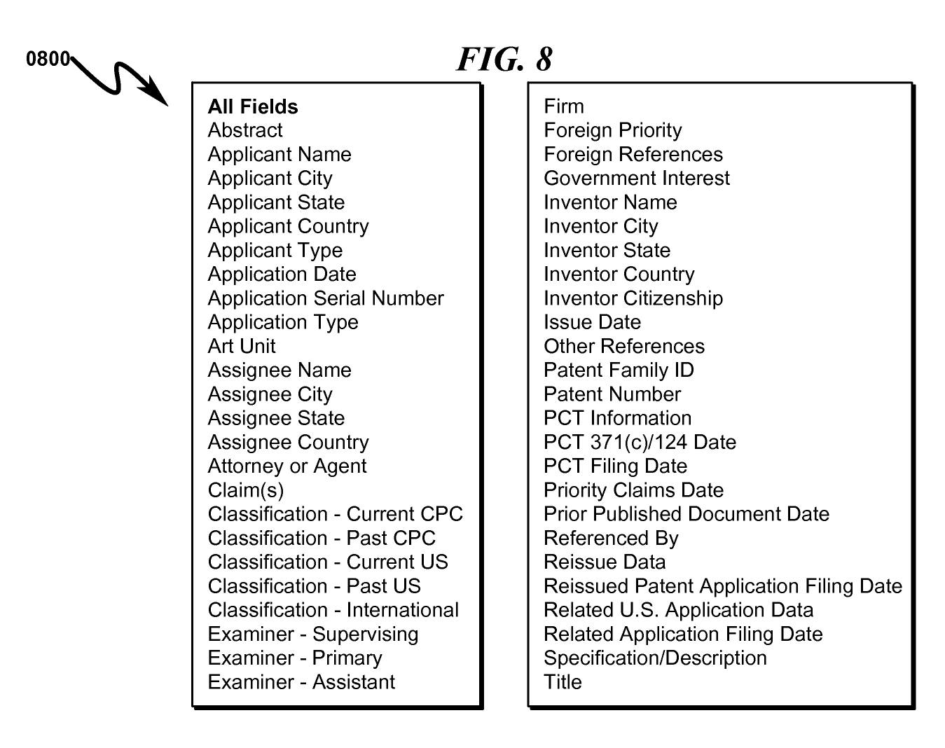

With respect to keyed database search/filtering methodologies, the present invention anticipates that a wide variety of IP-class specific keyed searches may be performed using keyed index search criterion. As generally depicted in FIG. 8 (0800), a general complement of patent-related key searches is anticipated that may incorporate various BOOLEAN search operators. Note, however, that application of these keyed searches across various IP databases maintained by the system permit more complex data analysis functions to be performed than could be accomplished using traditional BOOLEAN search criterion on public IP databases. For example, the following IP analysis scenarios can be performed using the present invention:
Overcoming an Examiner-Cited Reference. Find USPTO private Patent Application Information Retrieval (PAIR) data on a selected patent serial number. Extract all Examiner-cited art for the current office action. Cross-reference this to all other patent applications in public PAIR to determine how other patent attorneys responded to rejections based on this cited art. (Note that this requires cross-linking to other PAIR data, OCR of PAIR data, extraction of Examiner rejections and patent Applicant responses).
Determining Patent Influence. Enter an issued patent number. Search for all issued patents and patent applications in which the Examiner cited this as a prior art reference which was not overcome by the patent Applicant. (Note that this determines the market influence of the patent).
Determining Patent Breadth. Enter an issued patent number. Search for all issued patents and patent applications in which the Examiner or patent Applicant cited this as a prior art reference. (Note that this determines the breadth and possible value of the patent).
Determining Patent Breadth. Enter an issued patent number. Search for all issued patents and patent applications in which the Examiner or patent Applicant cited this as a prior art reference. Categorize these patents by assignee company and technology area. (Note that this determines the value of the patent to a particular company/industry).
Determining Industry Applicability. Enter an industry or product type. Search for all U.S. companies associated with the industry/product. Cross reference this company list to patent assignees and select associated patents sorted by patent classification. Generate graphs showing trending in each patent class over time. (Note that this can show technology trends in various parts of a given industry).
Art Unit Pendency. Select a patent art unit number. Search PAIR data to determine time differential between patent application date and patent issuance. Generate graph showing patent pendency over time. (Note that this can provide insight into the true pendency within an art unit).
Art Unit Allowance Rate. Select a patent art unit number. Search PAIR data to determine percentage of patent applications entering art unit that mature to allowance. Generate graph showing patent allowance rate over time. (Note that this information can provide insight into the potential for patent allowance in a given art unit).
Examiner Allowance Rate. Select a patent Examiner name. Search PAIR data to determine percentage of patent applications reviewed by Examiner that mature to allowance. Generate graph showing patent allowance rate by Examiner over time. (Note that this information can provide insight into the potential for patent allowance for a particular Examiner).
Examiner RCE Rate. Select a patent Examiner name. Search PAIR data to determine percentage of patent applications reviewed by Examiner that require a RCE in order to receive a Notice of Allowance. Generate graph showing RCE rate by Examiner over time. (Note that this information can provide insight into the realistic delays to be expected from a given Examiner).
Examiner Restriction Requirement Rate. Select a patent Examiner name. Search PAIR data to determine percentage of patent applications reviewed by Examiner in which the Examiner issues a Restriction Requirement that is traversed by the Applicant. Calculate the percentage of successfully traversed Restriction Requirements. (Note that this information can provide insight into the realistic possibility of overcoming an Examiner Restriction Requirement).
   One skilled in the art will recognize that this list is non-exhaustive and only illustrative of the cross-correlation analytic capabilities of the present invention.

### Exemplary System Architecture (0900)-(1300)

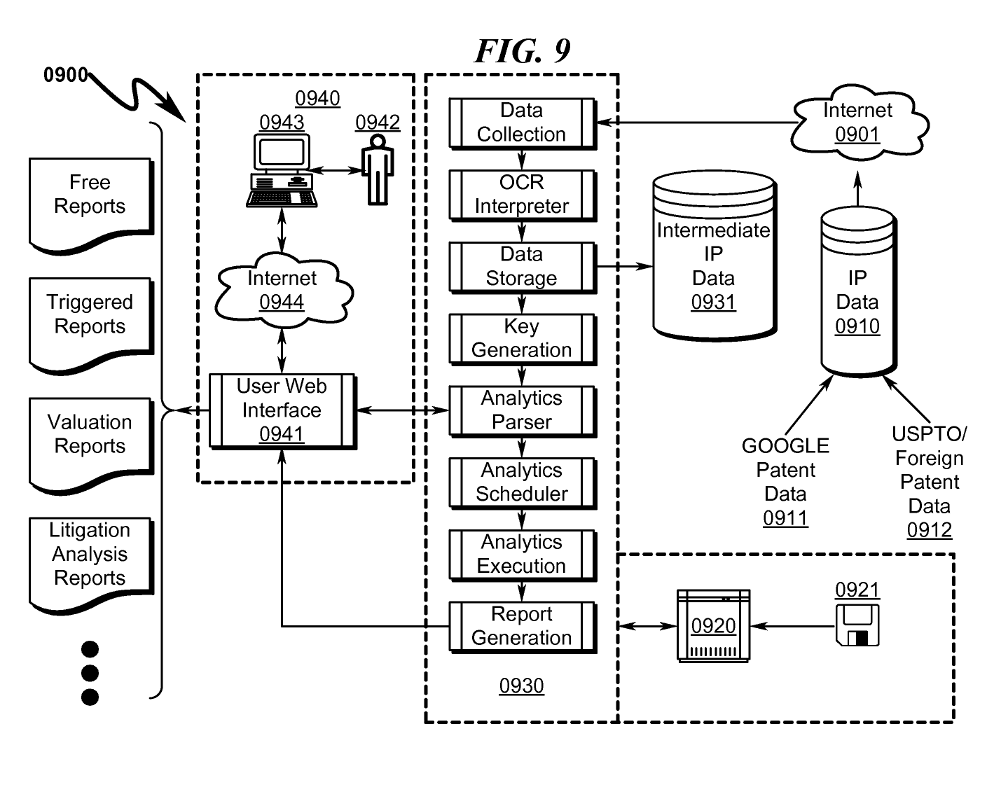

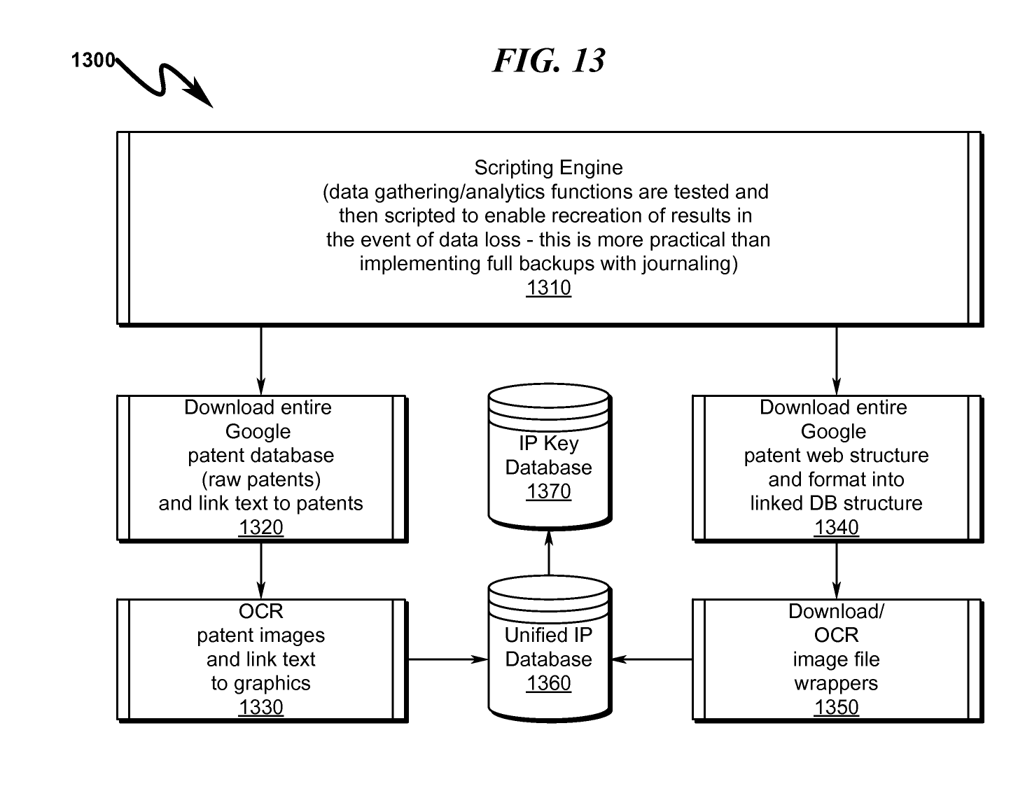

Several views of an exemplary invention system architecture are provided in FIG. 9 (0900)-FIG. 13 (1300). The objective in this exemplary system embodiment is to provide a graphical interface that permits analysis of patent/IP data across a variety of data sources that are not currently integrated in a form that permits rapid visualization of IP trends, patent portfolio valuation, patent litigation risk analysis, and quantification of patent allowance potential. One skilled in the art will recognize that this objective may vary based on the type of IP analytics desired in a particular application context.

### Exemplary Data Collection (0900)

As generally depicted in FIG. 9 (0900), the present invention may incorporate a data flow in which data is collected (0910) from a variety of data sources (0911, 0912) and transmitted over the Internet (0901) to a data server (0920) operating under control of machine instructions read from a computer readable medium (0921). This collected data is then processed by a series of software processes (0930) that include data collection, OCR conversion, data storage, key generation, etc. to generate internal data stores that represent easily searched data within the collected data. These software processes also incorporate an analytics parser linked to a web interface (0941) that enables a user (0942) to interact with a computer system (0943) and submit graphical queries via a computer network (0944) to the system.

The analytics parser within the software processes (0930) interpret the graphical network generated by the user web interface (0940) to then schedule generation of intermediate data sets via an analytics execution process and subsequently generate reports via a report generator that are presented to the user web interface (0940). Provisions in the system are included to provide a variety of free reports, triggered reports, valuation reports, or litigation analysis reports based on settings within the graphical query submitted to the analytics parser via the user web interface (0940).

It is significant to note that raw source IP data (0911, 0912) as combined (0910) is not necessarily used as the direct source for IP analytics functions (0930). Rather, this data is analyzed to generate associations between text and graphical data to produce Intermediate IP Data (0931) that has been both parsed and analyzed to correct known errors and cross-link information between the text and graphical data. Once established, this information need not be changed except for situations in which the original source documents (0911, 0912) are modified or updated.

### Exemplary Data Flow (1000)

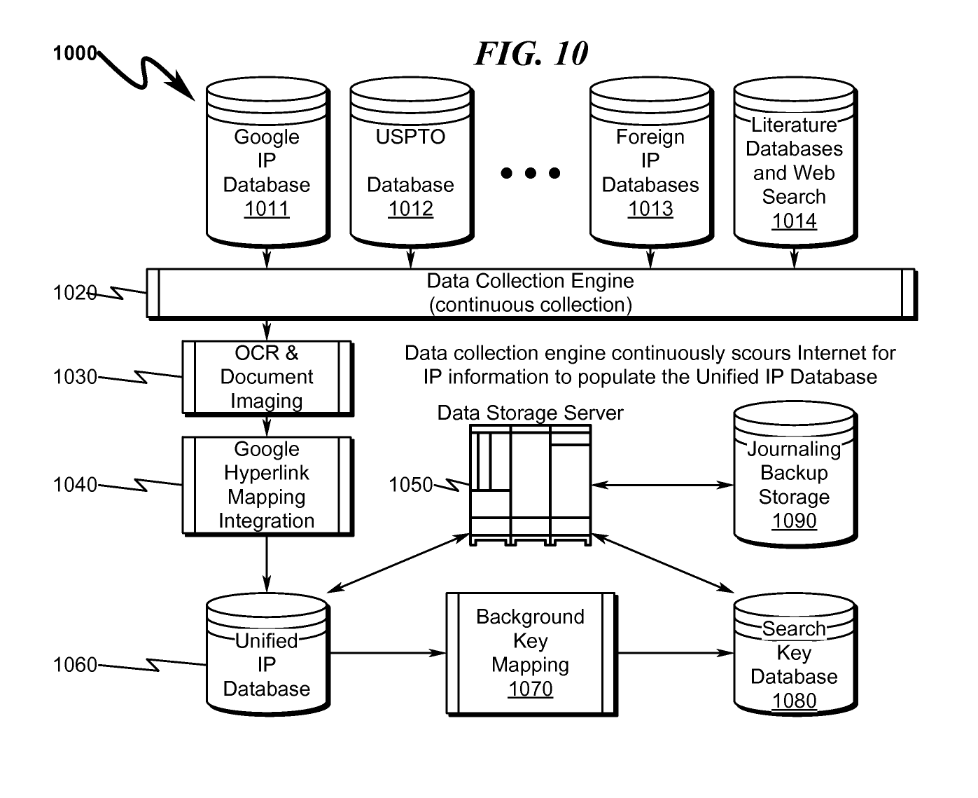

As generally depicted in FIG. 10 (1000), a typical data flow for the system incorporates a variety of source datasets (1011, 1012, 1013, 1014) that are continuously scanned for updates (1020) by a computer system and then imaged/OCRed (1030) by one or more processors. At this point hyperlinks between the data elements are generated (1040) by utilizing existing GOOGLE® hyperlinks as well as incorporating other hyperlinks between related data (for example, references in a patent to other patents, drawing references within the patent, keyed word/phrase references within the patent and other patents, etc.). Once this information is generated a data storage server (1050) creates a unified IP database (1060) incorporating all of this information. A background key mapping process (1070) scans this unified database and connects links between the various hyperlink trees to form a unified key search thread associating all information within the database to other related information on patents and other publications. This resulting key search database (1080) is then stored and a journal backup (1090) is created for tracking purposes.

As depicted in this diagram, the present invention anticipates a much wider range of IP integration than is possible using singular IP databases from a single country. This system also permits integration of literature searches and web searches (1014) within the framework of IP analytics to allow prior art searching at a level not previously possible or feasible using conventional database search techniques. The continuous scanning features of these searching, database unification, and key mapping operations also permits triggered reporting of changes in IP landscape associated with a variety of search criterion that were not previously possible using automated or manual techniques.

### Exemplary Data Sources (1100)

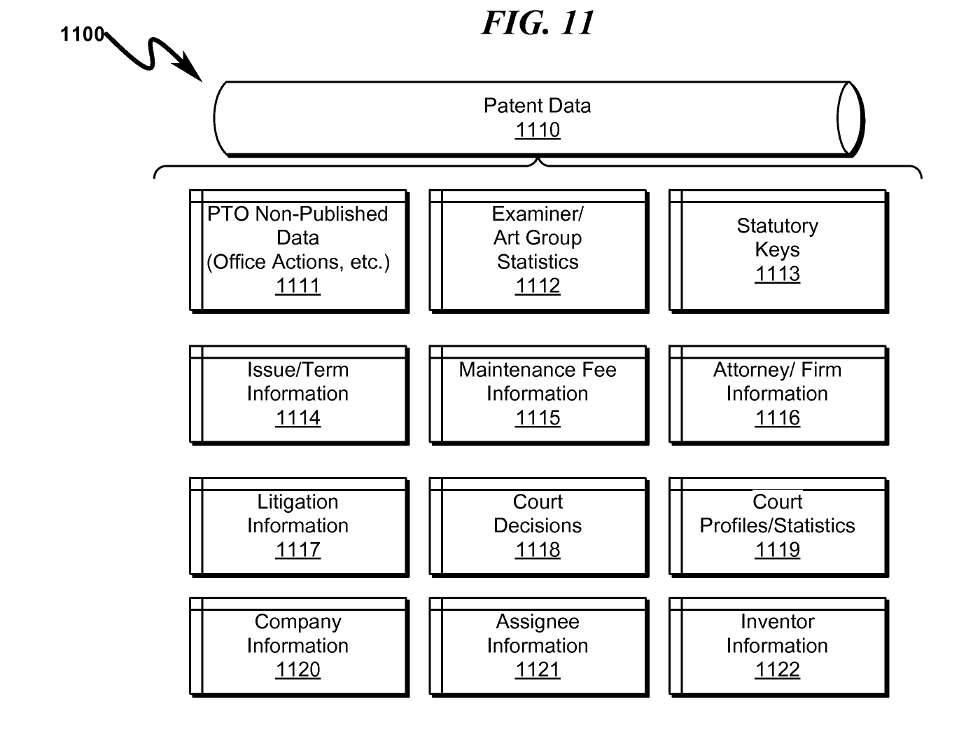

FIG. 11 (1100) illustrates several exemplary data sources that may be integrated within the unified IP database (1110). Many of these are unrelated to published patent databases but are of significant interest when cross-linked to information contained within patent databases. Examples of this may include:
PTO Non-Published Data (Office Actions, etc.) (1111)—There is a wealth of historical information contained in PTO and other patent office memoranda that is not generally searchable by the public. This information contains information on the prosecution history of particular patents but also trends in how patents are handled by the patent office. This information can be of value in determining strategies to use in both pursuing patents and deciding what types of patents to pursue before the PTO and other patent offices.
Examiner/Art Group Statistics (1112)—This information can provide useful statistics on how particular art groups and Examiners are performing with respect to examination of patent applications in various art groups.
Statutory Keys (1113)—This information may be useful in determining what cases have been cited in examination of patent applications and the impact that these cases have had on the outcome of prosecution.
Issue/Term Information (1114)—This information provides data on patent term enforcement and expired patents. For example, it is possible to scan patents that are nearly expired or newly expired.
Maintenance Fee Information (1115)—This information provides data on patents that are close to a maintenance fee payment or which have expired due to failure to pay maintenance fees.
Attorney/Firm Information (1116)—This information provides data on clearance rates for particular firms/attorneys.
Litigation Information (1117)—This information cross references existing and newly filed court litigation against patents and their assignees.
Court Decisions (1118)—This information cross references litigation decisions against patents and their assignees.
Court Profiles/Statistics (1119)—This information provides statistics on court dockets, judgment verdicts, and case pendency.
Company Information (1120)—This information provides statistics on links between companies and their corporate tree structure.
Assignee Information (1121)—This information provides current assignee information based on current corporate structure and organization. Note that as corporate entities are combined/split, assignment right trees will vary accordingly.
Inventor Information (1122)—This information provides links to individual inventors and their relationships between assignees and corporate entities.

Other information may also be included in this integrated dataset as determined by application context. The key feature of this architecture is that information tangential to existing patent databases may be integrated together with existing patent database information to form new insights into the IP being analyzed. These insights may form the basis of business decisions that cannot be intelligently made using prior art patent database searching techniques.

### Background Event Triggering (1200)

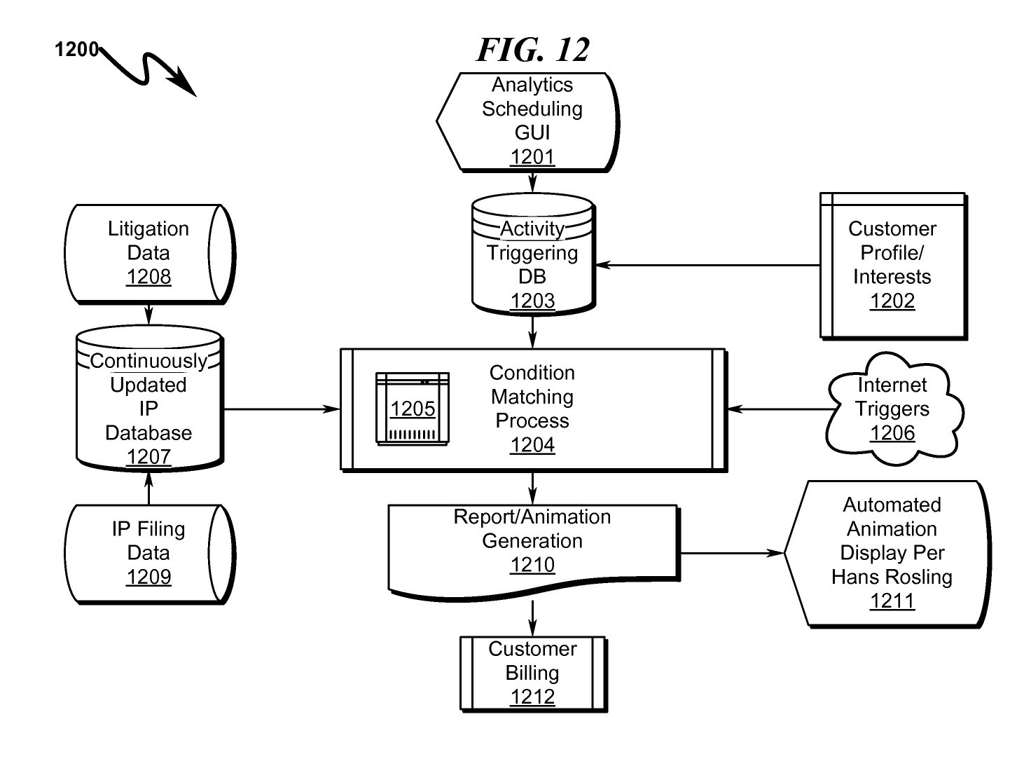

One aspect of the present invention that is significant to the IP analytics process is the concept of background event triggering which allows changes in IP database information to result in asynchronous report generation for an IP analytics user as depicted in FIG. 12 (1200). This feature permits a graphical data flow to be generated that may have as inputs information from a variety of IP or other databases that may change over time. The changes in this IP data source when properly filtered may trigger a reevaluation of reports or other information to be distributed to an IP analytics user.

As generally depicted in FIG. 12 (1200), this portion of the system may incorporate an analytics scheduling GUI (1201) that when combined with customer profiles/interests (1202) are used to generate an activity triggering database (1203) that provides a “watchlist” of events or information that should be considered relevant for the user. A condition matching process (1204) (running on a computer system (1205) monitors triggering events from the Internet (1206) and matches these to the continuously updated IP database (1207) (which may include a variety of daily updates from litigation data (1208), IP filing/prosecution/issuance data (1209)). Event trigger matches then trigger automated report generation (1210) (including automated animation displays (1211) for the user and automated customer billing (1212) based on the report as generated.

### Scripted Data Extraction (1300)

The present invention anticipates that the techniques for extraction of data from existing IP databases and other sources may change over time. As such, the data extraction process may need to be performed multiple number of times as data extraction techniques improve and information regarding the particular datasets is gathered. If a snapshot of a particular IP database is taken at a given point in time, the information extracted from this database will be static, even if the underlying data in the source IP database is updated, corrected, or improved by the IP data source provider (such as in the case a patent image is rescanned, processed through an improved OCR engine, etc.).

The present invention solves this data coherency problem by providing a scripting engine (1310) that permits data gathering functions (1320, 1340) and analytics functions (1330, 1350) to run against source IP databases to generate the intermediate databases used to generate the hyperlinked IP data that forms the unified IP database (1360) and the key index data (1370). The combination of the hyperlinked IP data (1360) and key index data (1370) permit key fields (or combinations thereof) to be referenced within the GQD when generating the IAN that is used to form the basis of the IP analytics function specified by the user making the IP analytics query.

### Exemplary Graphical Reports (1400)-(2400)

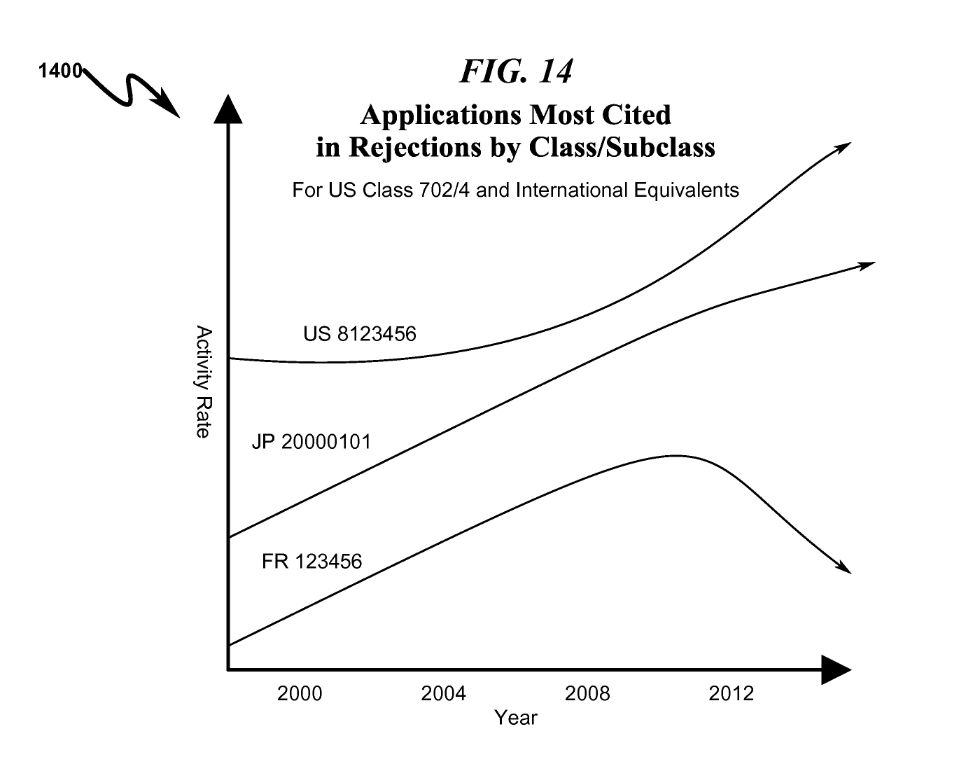

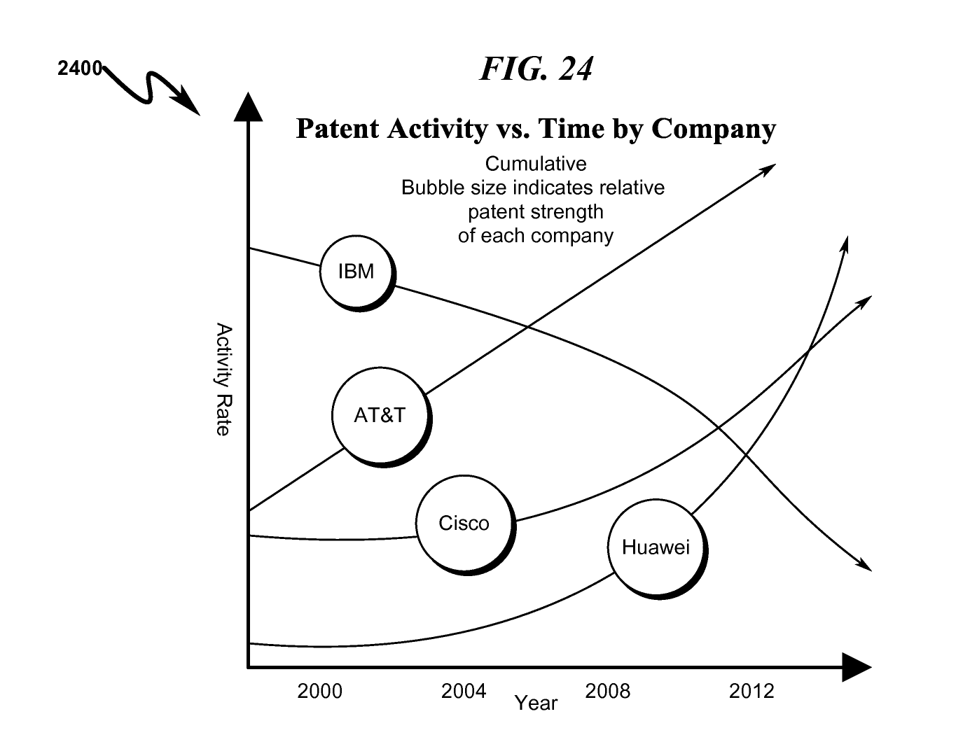

Several exemplary graphical reports that are possible using the teachings of the present invention are provided in FIG. 14 (1400)-FIG. 24 (2400). While graphical data is illustrated, the present invention anticipates that tabular/text data output may also be generated using this system. While in some cases the prior art permits manual extraction of information from patent related databases, there is no mechanism in the prior art to perform many types of important IP analytics functions as described in these exemplary graphs. This is especially true in trend curves that require graphing the number of returned entries on a query search, such as “What is IBM's most active patent class/subclass over the last decade?”, “What technology area (class/subclass) was the most active last year and how has it trended over the last decade?”, and numerous like analyses.

### Exemplary Patent Search Query (2500)-(2600)

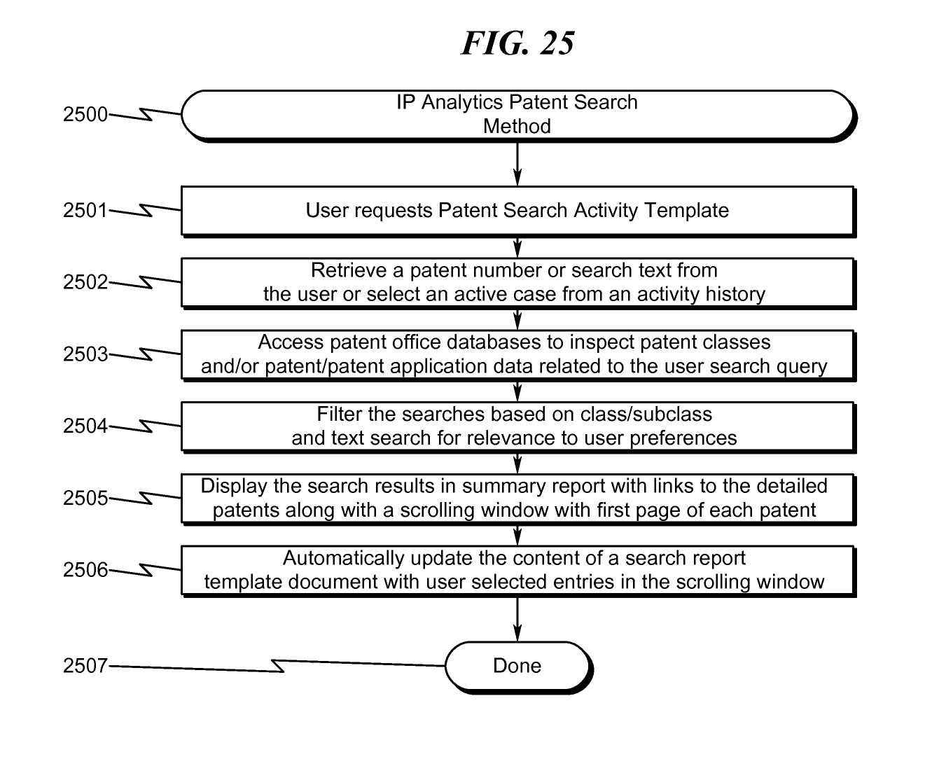

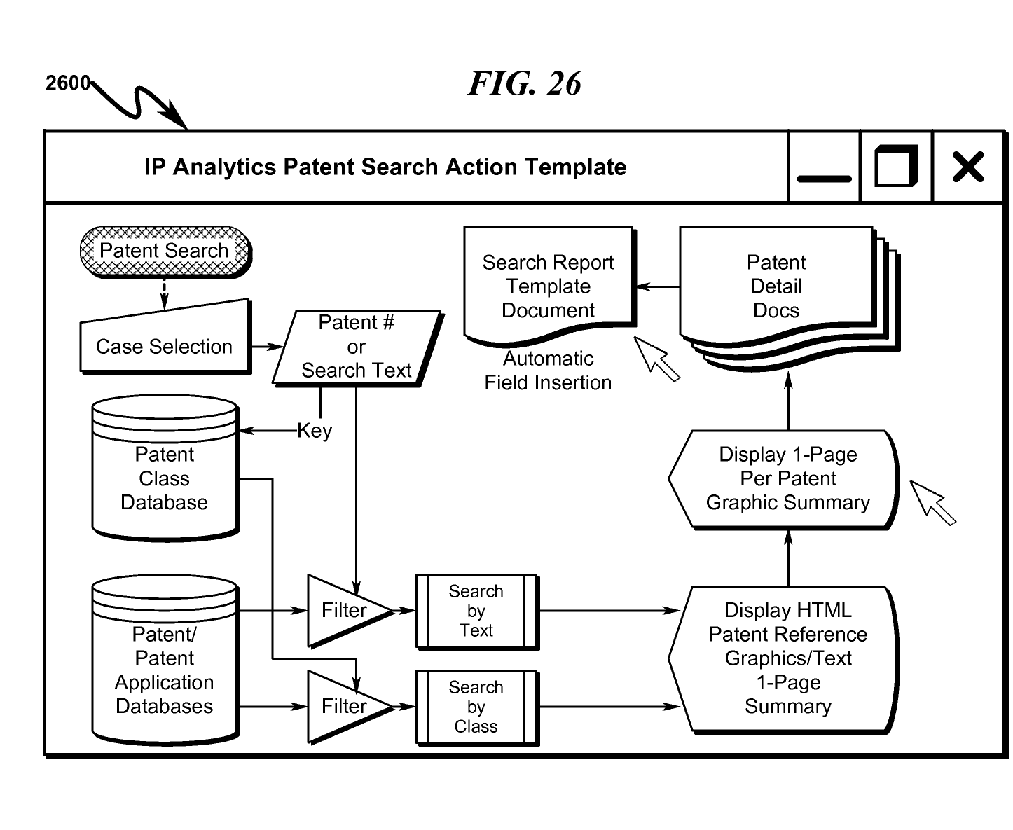

An exemplary IP analytics query relating to a typical patent search function is detailed in the method flowchart of FIG. 25 (2500) and the corresponding IAN graphical network of FIG. 26 (2600). This method generally includes the following steps:
(1) Activating patent search activity template comprising an IAN flow similar to that depicted in FIG. 26 (2600) (2501);
(2) Retrieving a patent number or search text from the user or selecting an active case from an activity history (2502);
(3) Access patent office databases to inspect patent classes and/or patent/patent application data related to the user search query (2503);
(4) Filtering the searches based on class/subclass and text search for relevance to user preferences (2504);
(5) Displaying the search results on a summary report incorporating links to the detailed patent documents along with a scrolling window incorporating the first page of each patent (2505); and
(6) Automatically updating the content of a search report template document with user selected entries in the scrolling window (2506).

One skilled in the art will recognize that this method could not be performed using conventional patent office or commercial database searches because it requires a level of coordinated knowledge between disparate datasets that is not currently possible using prior art IP analytics tools.

Patent practitioners (and in many cases patent Examiners) are well aware that the generation of a patent search report for a given technology area or invention disclosure can be a time consuming and arduous task. This is in part because information related to a given patent, technology, disclosure, and class/subclass must be manually entered and linked manually outside of existing IP databases. Furthermore, once the results of IP queries are obtained, they must be manually combined to generate the necessary reports associated with the search. All of this process fails to integrate much of the information outside of the patent IP databases and as such often poorly reflects the true scope of the prior art with respect to a given technology or invention. As a result, many patent searches using these manual techniques often miss important prior art that is relevant to the patentability of an invention or the validity of an issued patent.

Of particular interest in this scenario is the ability to merge patent related data from searched patents into a patent search report template without manual rekeying or cut/paste operations. Fields within the patent search report template (such as tables and the like) can be automatically filled in with information taken from the patent detail documents by merely selecting these documents and dragging them to the search report template or selecting them for further analysis and processing prior to their inclusion in the patent search report. This feature ensures that information contained in the patent detail document (such as abstract/claims info and bibliographic data) is accurately transported to the patent search report without the possibility of human error.

### Exemplary Patent Prosecution Query (2700)-(2800)

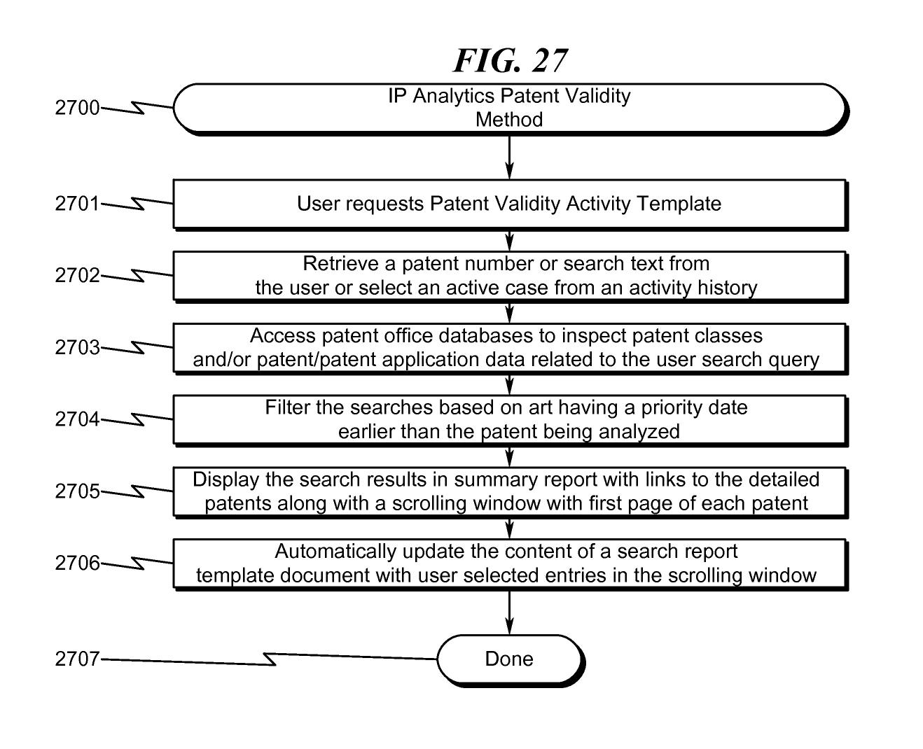

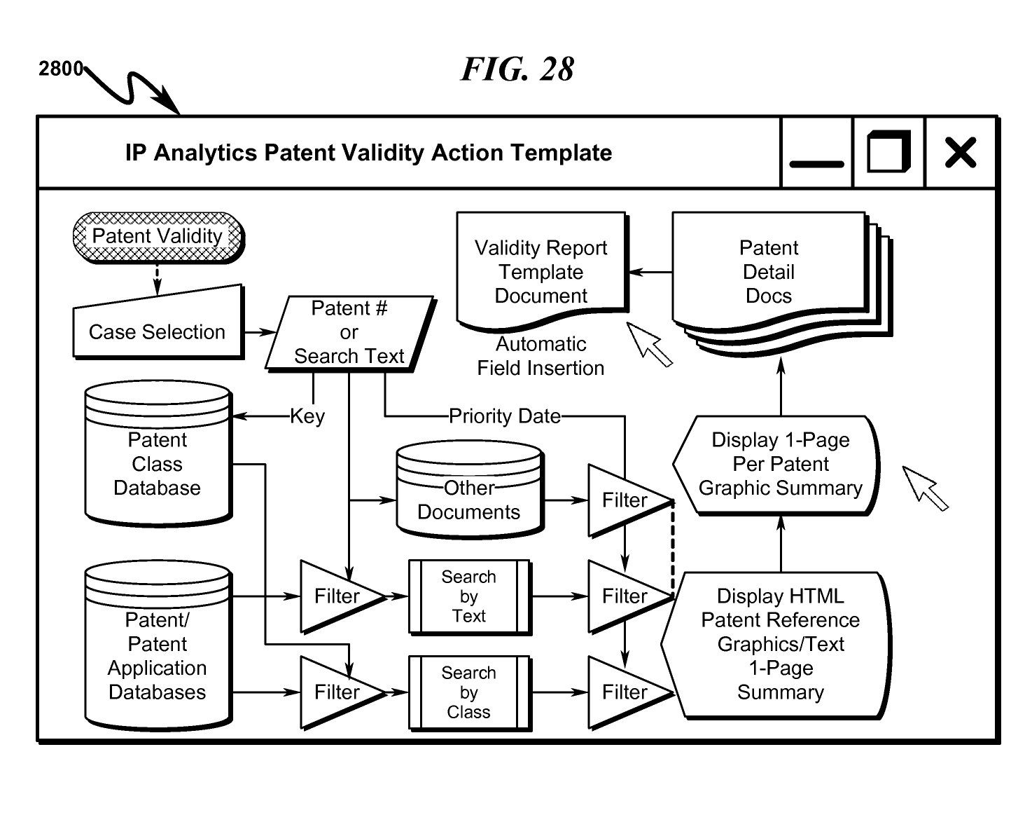

An exemplary IP analytics query relating to a typical patent validity function is detailed in the method flowchart of FIG. 27 (2700) and the corresponding IAN graphical network of FIG. 28 (2800). This method generally includes the following steps:
(1) Activating a patent validity activity template comprising an IAN flow similar to that depicted in FIG. 28 (2800) (2701);
(2) Retrieving a patent number or search text from the user or selecting an active case from an activity history (2702);
(3) Access patent office databases to inspect patent classes and/or patent/patent application data related to the user search query (2703);
(4) Filtering the searches based on art having a priority date earlier than the patent being analyzed (2704);
(5) Displaying the search results on a validity summary report incorporating links to the detailed patent documents along with a scrolling window incorporating the first page of each patent (2705); and
(6) Automatically updating the content of a validity report template document with user selected entries in the scrolling window (2706).

One skilled in the art will recognize that this method could not be performed using conventional patent office or commercial database searches because it requires a level of coordinated knowledge between disparate datasets that is not currently possible using prior art IP analytics tools.

Of particular interest in this scenario is the ability to merge prior art patent related data from searched patents (or other prior art references such as industry publications, technical journals, and the like) into a patent search report template without manual rekeying or cut/paste operations. Fields within the patent validity report template (such as tables and the like) can be automatically filled in with information taken from the patent detail documents by merely selecting these documents and dragging them to the validity report template or selecting them for further analysis and processing prior to their inclusion in the patent validity report. This feature ensures that information contained in the patent detail document (such as abstract/claims info and bibliographic data) is accurately transported to the patent validity report without the possibility of human error.

### Exemplary Provisional Patent Priority Query (2900)-(3000)

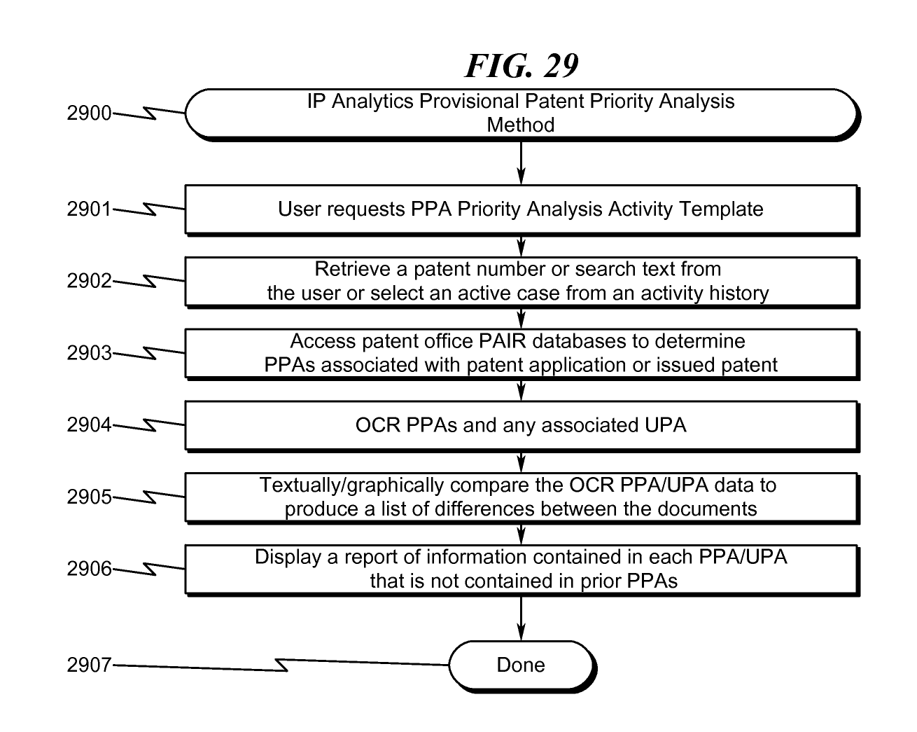

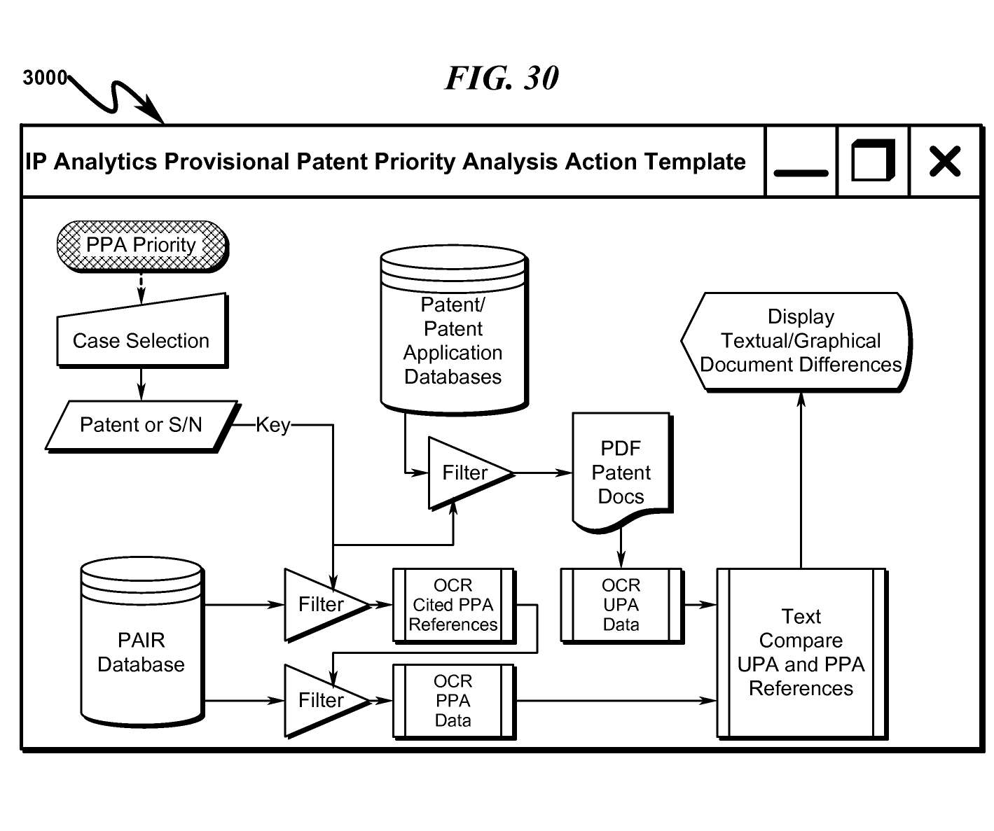

An exemplary IP analytics query relating to a typical provisional patent application priority analysis function is detailed in the method flowchart of FIG. 29 (2900) and the corresponding IAN graphical network of FIG. 30 (3000). This method generally includes the following steps:
(1) Activating a provisional patent application priority analysis activity template comprising an IAN flow similar to that depicted in FIG. 30 (3000) (2901);
(2) Retrieving a patent application serial number (SN) or patent number from the user or selecting an active case from an activity history (2902);
(3) Access patent office PAIR databases to determine PPAs associated with patent application or issued patent (2903);
(4) OCR PPAs and any associated UPA to extract textual and graphical information for comparison (2904);
(5) Textually/graphically compare the OCR PPA/UPA data to produce a list of differences between the documents (2905); and
(6) Display a report of information contained in each PPA/UPA that is not contained in prior PPAs (2906).

One skilled in the art will recognize that this method could not be performed using conventional patent office or commercial database searches because it requires a level of coordinated knowledge between disparate datasets that is not currently possible using prior art IP analytics tools.

This tool is particularly effective in isolating “thin” provisional patent application (PPA) disclosures in which the PPA either does not fully enable the invention or in which information in the PPA differs from that filed in the subsequent utility patent application. This information can have a significant impact on the validity of patents in countries that adhere to an absolute novelty requirement and is also very important in situations where a first-to-file priority system is in effect and information contained in the utility patent application (UPA) was not contained in the PPA priority document and there is an interference with a third-party patent application filed between the PPA and UPA that discloses and claims the subject matter in question.

### Exemplary Patent Prosecution Query (3100)-(3200)

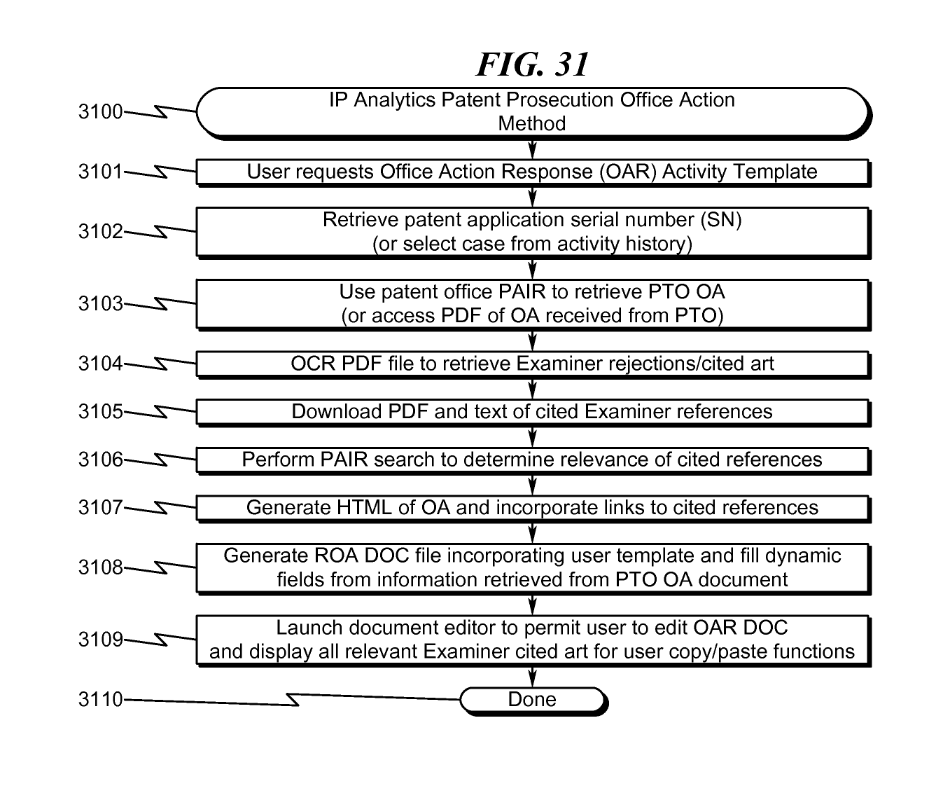

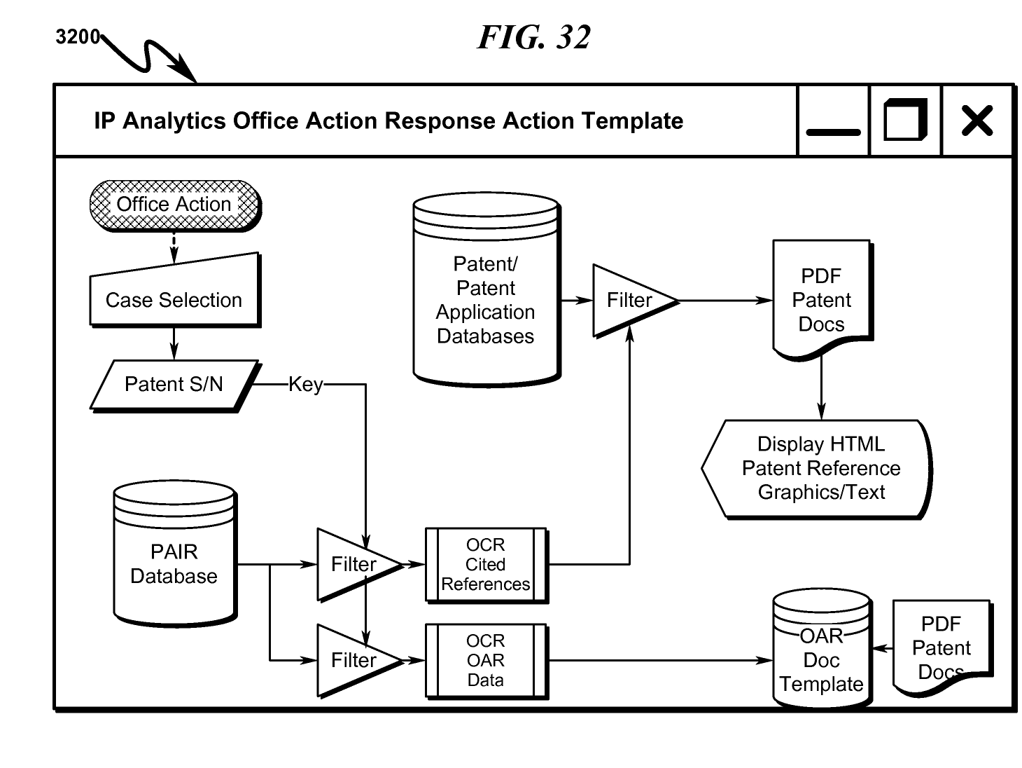

An exemplary IP analytics query relating to a typical patent prosecution (Office Action Response) function is detailed in the method flowchart of FIG. 31 (3100) and the corresponding IAN graphical network of FIG. 32 (3200). This method generally includes the following steps:
(1) Activating an Office Action Response (OAR) activity template comprising an IAN flow similar to that depicted in FIG. 32 (3200) (3101);
(2) Retrieving a patent application serial number (SN) from the user or selecting an active case from an activity history (3102);
(3) Access patent office PAIR data to retrieve the currently active Office Action (OA) or accessing a PDF file of the OA as received from the patent office (3103);
(4) Scanning by OCR the OA PDF file to retrieve the patent Examiner rejections and cited art (3104);
(5) Downloading the PDF and text of the Examiner-cited references and presenting these collectively for review by the user (3105);
(6) Performing a PAIR search among other patent application prosecutions to determine the relevance of the cited references (3106);
(7) Generating HTML of the OA and incorporating links to the cited Examiner references (3107);
(8) Generating an Office Action Response (OAR) document file incorporating user template preferences and filling in dynamic fields from information retrieved from the patent office OA document (3108);
(9) Launching a document editor to allow the user to edit the OAR document file and display all relevant Examiner cited art for the user to copy/paste as needed into the OAR document (3109).

One skilled in the art will recognize that this method could not be performed using conventional patent office or commercial database searches because it requires a level of coordinated knowledge between disparate datasets that is not currently possible using prior art IP analytics tools.

Patent practitioners are often burdened by the process of responding to USPTO and other patent agency Office Actions by virtue of the fact that these documents are not typically provided in a form that permits easy extraction of text information. Furthermore, since much of the document corresponding to an Office Action Response is information that must be extracted from the Office Action, the amount of manual effort in transcribing this information from the USPTO OA to the OAR is significant and as a result quite costly. The proposed methodology as depicted in the above IAN automates this process and permits the patent practitioner the luxury of concentrating on the substantive portions of the response rather than spending time on the administrative functions associated with generating the OAR document.

Additionally, it should be noted that this IAN is configured to preload the Examiner cited art to permit the patent practitioner access to both the art cited as well as text conversions that may be cut/pasted into the OAR. This combined result may be packaged and sent to the client for review/comment as part of the client notification materials sent via e-mail.

### Exemplary Art Group Analytics Query (3300)-(3400)

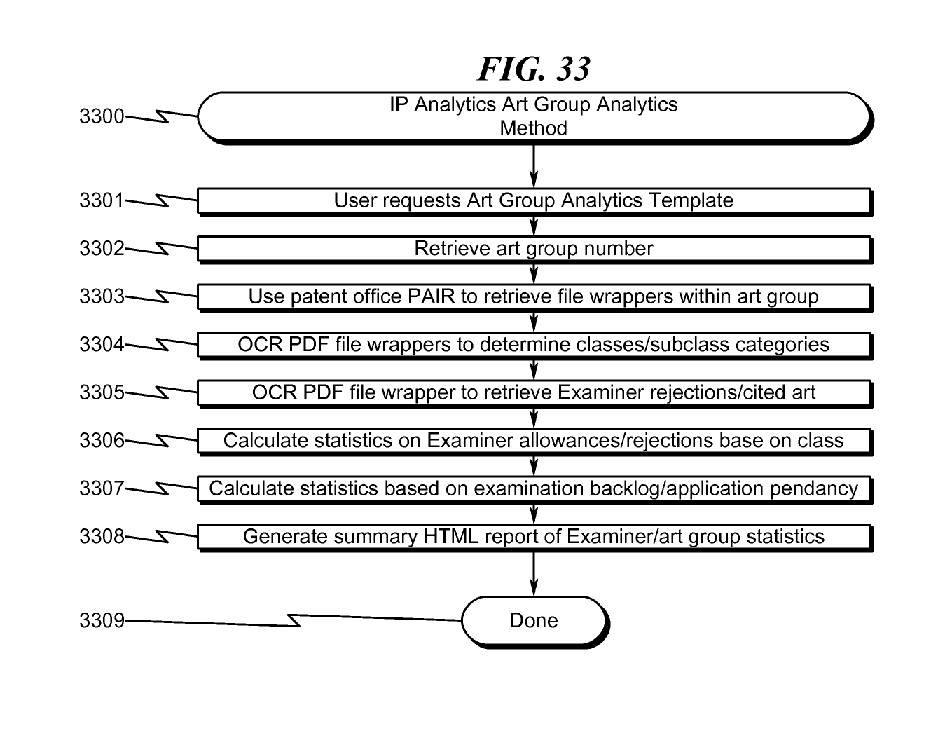

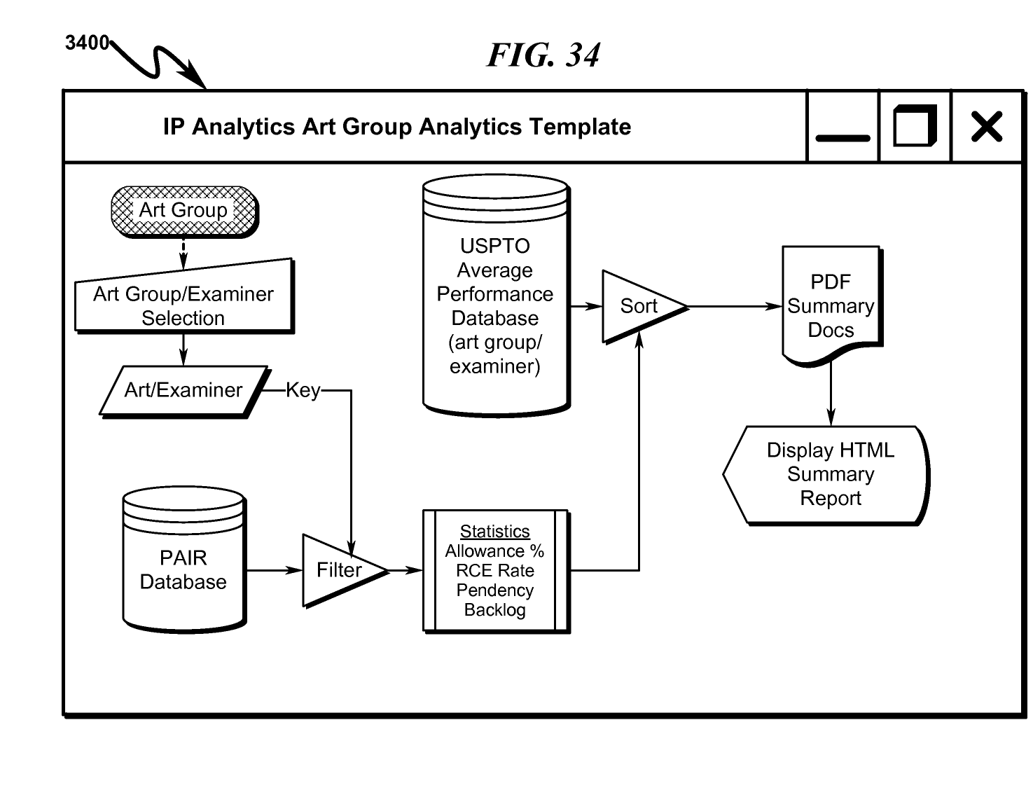

An exemplary IP analytics query relating to a patent art group analytics function is detailed in the method flowchart of FIG. 33 (3300) and the corresponding IAN graphical network of FIG. 34 (3400). In this query, the user wishes to determine statistics regarding the allowance/rejection rate of a particular patent art group or specific statistics regarding the performance of an individual patent examiner. This information along with pendency timelines and art group backlog information can be used in some circumstances to weigh the obstacles associated with patent examination under a particular art group or patent examiner and thus provide the basis for counseling clients who submit patent applications in a particular art group area. As generally depicted in FIG. 33 (3300), this method generally includes the following steps:
(1) Activating an Art Group Analytics template comprising an IAN flow similar to that depicted in FIG. 34 (3400) (3301);
(2) Retrieving an art group number or examiner name from the user or selecting an active case from an activity history to extract the appropriate art group/examiner identification (3302);
(3) Access patent office PAIR data to retrieve file wrappers associated with a particular art group and/or examiner (3303);
(4) Scanning by OCR the OA PDF file wrappers to retrieve statistics associated with the patent examination process which may include details on allowance rate, rejection rate, RCE rate, appeal rate, patent examination pendency, office action reply time, art group backlog, etc. (3304);
(5) Sorting the statistics based on art group and examiner and providing a comparison to that of average USPTO art groups, other examiner averages, and other examiners in the same art group (3305);
(6) Generating a PDF report of the summary sorting process (3306); and
(7) Generating HTML of the PDF report and displaying the summary report to the user on a graphical user interface (3307).

One skilled in the art will recognize that this method could not be performed using conventional patent office or commercial database searches because it requires a level of coordinated knowledge between disparate datasets that is not currently possible using prior art IP analytics tools.

One skilled in the art will recognize that specific information on particular art group performance is impossible to determine using conventionally available information from the USPTO or other sources. This information is of particular interest in determining the time to first Office Action and expected pendency of the patent application within a particular art group and examiner. This information can be critical in determining patent prosecution strategies to move the patent process forward to completion in the most efficient manner.

### Exemplary Litigation Query (3500)-(3600)

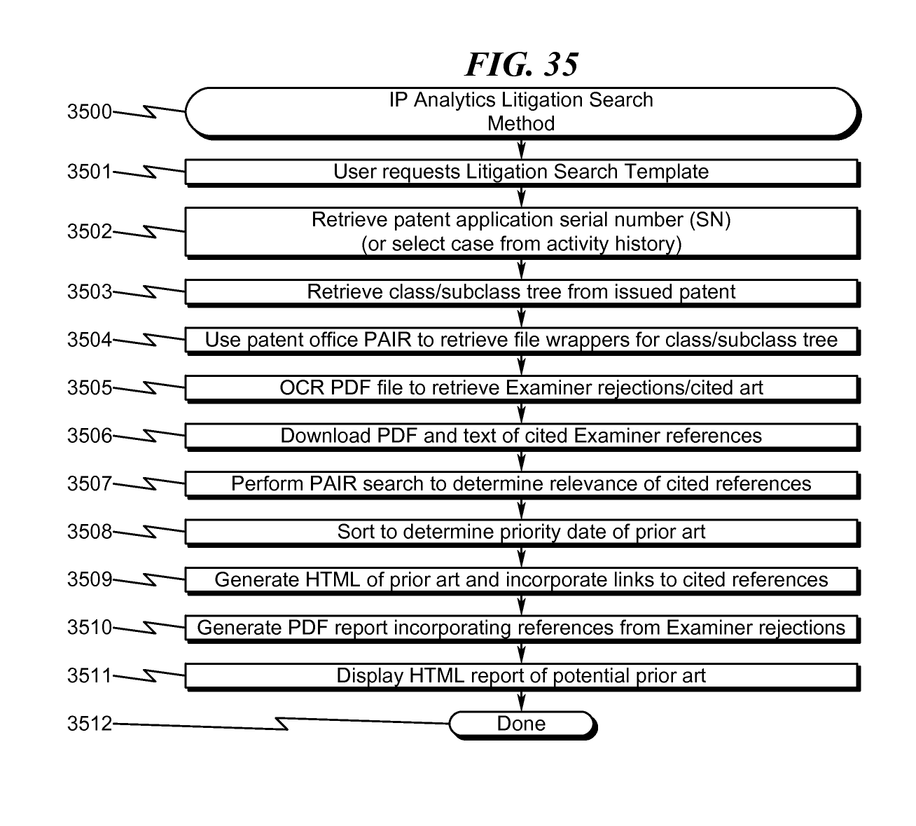

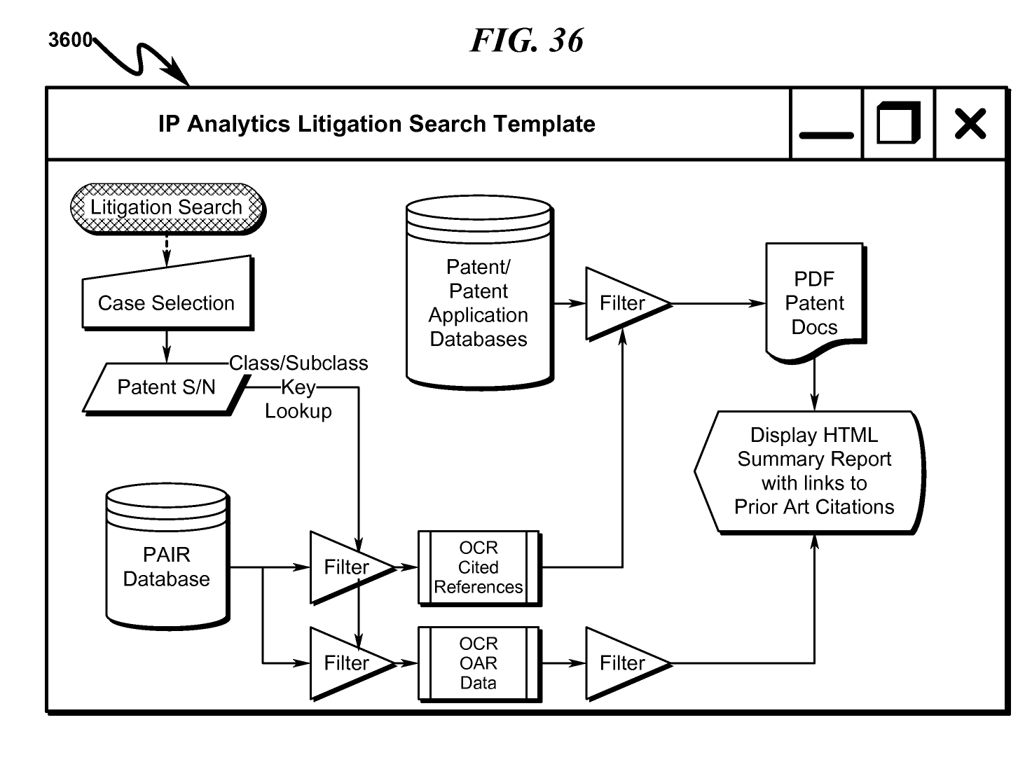

An exemplary IP analytics query relating to a litigation function is detailed in the method flowchart of FIG. 35 (3500) and the corresponding IAN graphical network of FIG. 36 (3600). In this query, the user wishes to find prior art that may invalidate a patent that is currently in litigation. This may typically involve searching patent databases to find art that predates a patent filing but which has been used to reject a patent application in a particular class/subclass. The present invention may incorporate a method to achieve this functionality by scanning both PAIR data and issued patent data (which may be sourced from a variety of domestic and foreign patent databases). As generally depicted in FIG. 35 (3500), this method generally includes the following steps:
(1) Activating a Litigation Search template comprising an IAN flow similar to that depicted in FIG. 36 (3600) (3501);
(2) Retrieving patent number(s), serial number(s), assignee name(s) or other patent identification information from the user or selecting an active case from an activity history to extract the appropriate patent/portfolio identification (3502);
(3) Retrieving the relevant class/subclass identifiers for the issued patent(s) (3503);
(4) Access patent office PAIR data to retrieve file wrappers associated with the identified class/subclasses (3504);
(5) OCRing the file wrappers to extract examiner-cited prior art and rejection history (3505);
(6) Downloading issued patent PDFs associated with the selected prior art (3506);
(7) Performing a PAIR search to determine the relevance of the cited references (3507);
(8) Sorting to determine the priority date of the selected prior art (3508);
(9) Generating HTML of the prior art and incorporating links to the cited references (3509);
(10) Generating PDF reports incorporating references from examiner rejections (3510); and
(11) Generating a HTML summary report of potential prior art that would invalidate the patent (3511).

One skilled in the art will recognize that this method could not be performed using conventional patent office or commercial database searches because it requires a level of coordinated knowledge between disparate datasets that is not currently possible using prior art IP analytics tools. Additionally, often references to particular prior art are buried within PAIR documents and without some form of coordinated OCR search that is sorted to both the cited prior art and the associated priority date it is very difficult to determine what art is relevant in invalidating a litigated patent.

### Exemplary Patent/Portfolio Valuation Query (3700)-(3800)

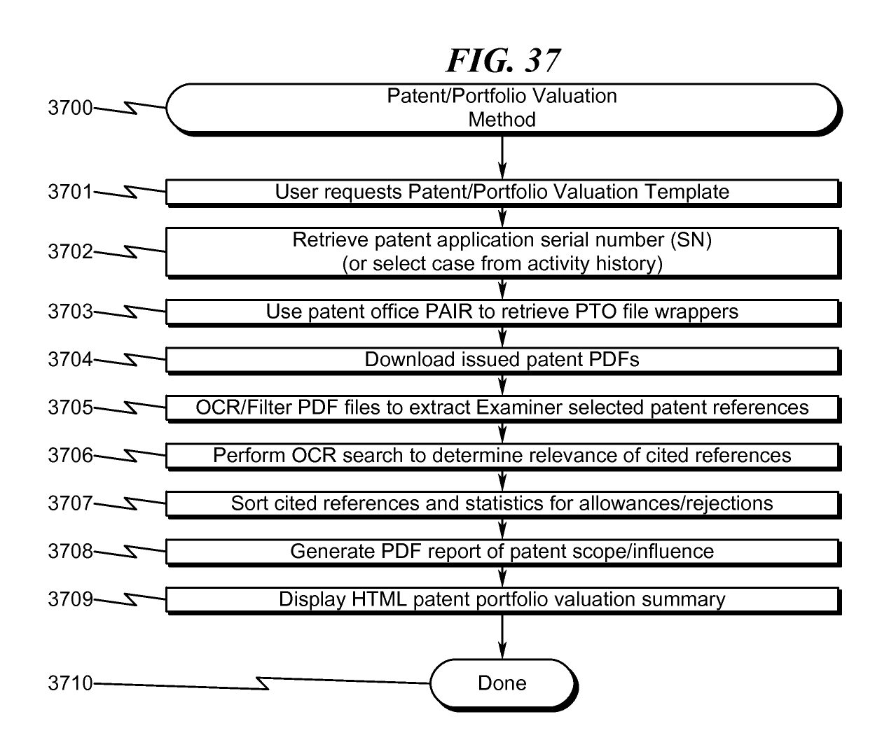

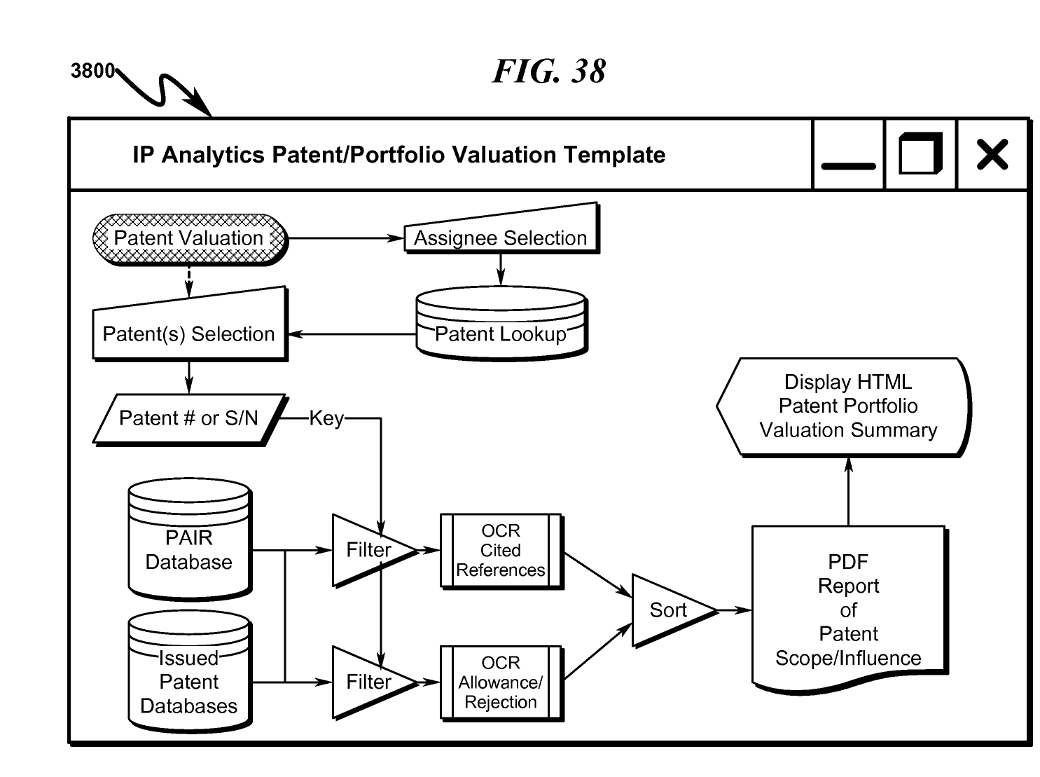

An exemplary IP analytics query relating to a patent/portfolio valuation function is detailed in the method flowchart of FIG. 37 (3700) and the corresponding IAN graphical network of FIG. 38 (3800). In this query, the user wishes to perform a valuation of a patent, group of patents, or patents associated with a particular assignee. This information can be inferred in some circumstances from the number of times a particular patent is referenced by subsequently issued patents, patent applications that are rejected based on the citation of a particular patent, and patent applications that are allowed based on amendments to overcome rejections based on the cited patent or patents. Particular assignees may have numbers of patents that are referenced in this manner and thus the task of determining the “scope of influence” for a particular patent or patent portfolio is extremely difficult using any currently available prior art techniques. The present invention may incorporate a method to achieve this functionality by scanning both PAIR data and issued patent data (which may be sourced from a variety of domestic and foreign patent databases). As generally depicted in FIG. 37 (3700), this method generally includes the following steps:
(1) Activating a Patent/Portfolio Valuation template comprising an IAN flow similar to that depicted in FIG. 38 (3800) (3701);
(2) Retrieving patent number(s), serial number(s), assignee name(s) or other patent portfolio identification information from the user or selecting an active case from an activity history to extract the appropriate patent/portfolio identification (note that selection of an assignee as the starting point in this patent/portfolio search may require additional ownership searching within the data processing network depicted in FIG. 38 (3800)) (3702);
(3) Access patent office PAIR data to retrieve file wrappers associated with the selected patent/portfolio (3703);
(4) Downloading issued patent PDFs associated with the selected patent/portfolio (3704);
(5) Scanning by OCR the PDF file wrappers/patents to retrieve information on references to the selected patent/portfolio (3705);
(6) Generating patent/portfolio reference statistics to determine the relevance of the selected patent/portfolio to patent prosecution and patent issuance (3706);
(7) Sorting the patent/portfolio references to determine statistics for allowances/rejections based on citation of the patent/portfolio (3707);
(8) Generating a PDF report of the influence of the patent/portfolio on patent prosecution, class/subclass activity, and patent issuance (3708); and
(9) Generating HTML of the PDF report and displaying the summary report to the user on a graphical user interface (3709).

One skilled in the art will recognize that this method could not be performed using conventional patent office or commercial database searches because it requires a level of coordinated knowledge between disparate datasets that is not currently possible using prior art IP analytics tools. Additionally, the influence of a given patent in an art field thick with other patents may be difficult to discern unless it can be determined how the patent relates to other prior art. Thus, a report indicating a particular patent has reference statistics far in excess of other patents in a particular class/subclass is a good indicator of the technology influence exerted by the patent as well as the value of the patent. Similarly, a patent that is cited in numerous anticipation rejections of patent applications must exert a strong influence over the technology field.

### Coherent Automated Database Extraction (3900)-(4000)

### Automated Database Extraction System (3900)

A significant problem in gathering and categorizing IP analytics information is in the area of data coherency as it relates to the IP databases that are used in the analytics process. By this it is meant that the data on which the analytics relies must come from a wide variety of databases that are not under control of the system tasked to perform the analytics function. Additionally, the processes used to extract the IP analytics data from these source databases may change/improve over time and thus necessitate a reevaluation of the source database information.

In this context even “historical” databases which at first glance should remain static are often subject to updates and corrections as information within these databases is updated to correct errors or omissions. This situation might occur, for example, in the case of images of issued patents that are stored in a historical patent database. This information may have missing pages, corrupted image files, or be subject to rescan in some circumstances where a clearer copy of the original document has been located for scanning or a scanner with higher resolution is used to scan an original document.

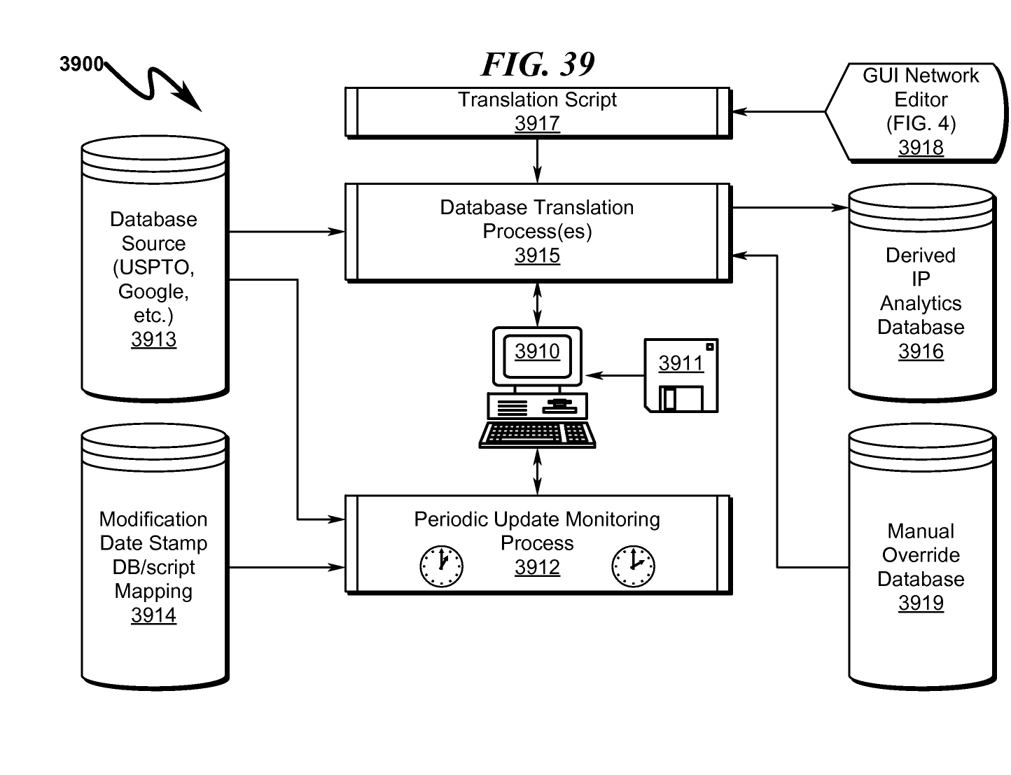

The problem with these updates is that in many circumstances the present invention must rely on a processed (derived) form of the original source database in order to create search keys, translate image information using OCR processes, and map image information associated with drawings and other graphical information. The present invention in many preferred embodiments addresses this issue as depicted in FIG. 39 (3900) in the following manner. A computer system (3910) executing instructions read from a computer readable medium (3911) executes a periodic monitoring process (3912) that inspects a series of database sources (3913) as to their database modification dates. These modification dates are then compared to a modification date database (3914) which contains a mapping of source database name to modification date. If the modification date of the database is determined to be newer than that stored in the modification date database (3914), a database translation process (3915) is executed to translate the source IP analytics database (3913) to a derived IP analytics database (3916).

The database translation processes (3915) are coordinated based on one or more translation scripts (3917) that are generated using a graphical user interface (3918) that operates using a data flow network editor interface as generally depicted in FIG. 4 (0400). Thus, the operations associated with the creation of the derived database (3916) may be accomplished using tools similar to that used to manipulate the derived databases to create finalized IP analytics reports. In this context the use of “derived” databases using the graphical editor in conjunction with primitive function operators (such as OCR, indexing, search, select, sorting, etc.) may be used to generate the derived data in a manner identical to the creation of intermediate datasets in a conventional IP analytics data flow.

It should be noted in this context that while the derived databases (3916) may become “stale” and require reevaluation of the source databases (3913), it is equally possible that the translation processes (3915) and/or translation scripts (3917) may be modified or updated and thus require recreation of the derived IP analytics database (3916). Thus, the modification date stamp database (3914) may include information on the translation processes (3915) and translation scripts (3917) so that when these processing items are modified the corresponding derived IP analytics database (3916) may be updated by forcing a retranslation of the corresponding source database (3913). This capability is important as modifications to the data extraction technology associated with the source database (3913) to derive database (3916) translation will by necessity evolve over time and maintenance of a coherent derived database (3916) may not reliable using manual translation methods.

In some circumstances the source database (3913) may contain errors or other artifacts that must be corrected manually. This might, for example, occur in situations where an error or other database artifact has been detected but has yet to be corrected (or may never be corrected) in the source database (3913). For example, a patent image database may contain a patent in which the word “patient” is misspelled as “patent” and is an obvious error. This misspelling will be duly translated using OCR technology as “patent” using present invention derived database translation processes, but still does not accurately represent the information content in the original source IP database. In this circumstance the system may be configured with a manual override database (3919) that permits manual patches/edits to be applied to the source database (3913) on a conditional basis so that the derived database (3916) may be properly constructed using the combination of translation scripts (3917) and translation processes (3915). In the example provided, the work “patent” may be replaced by “patient” in the derived database or in the OCR translation by a manual override entry in the database (3919) that is associated with a specific IP source database (3913) entry or in some circumstanced with a group of selected entries in the IP source database (3913). Once this override correction has occurred, the resulting derived databases used as the basis for user IAN queries will be properly configured to produce the correct and expected query results.

### Automated Database Extraction Method (4000)

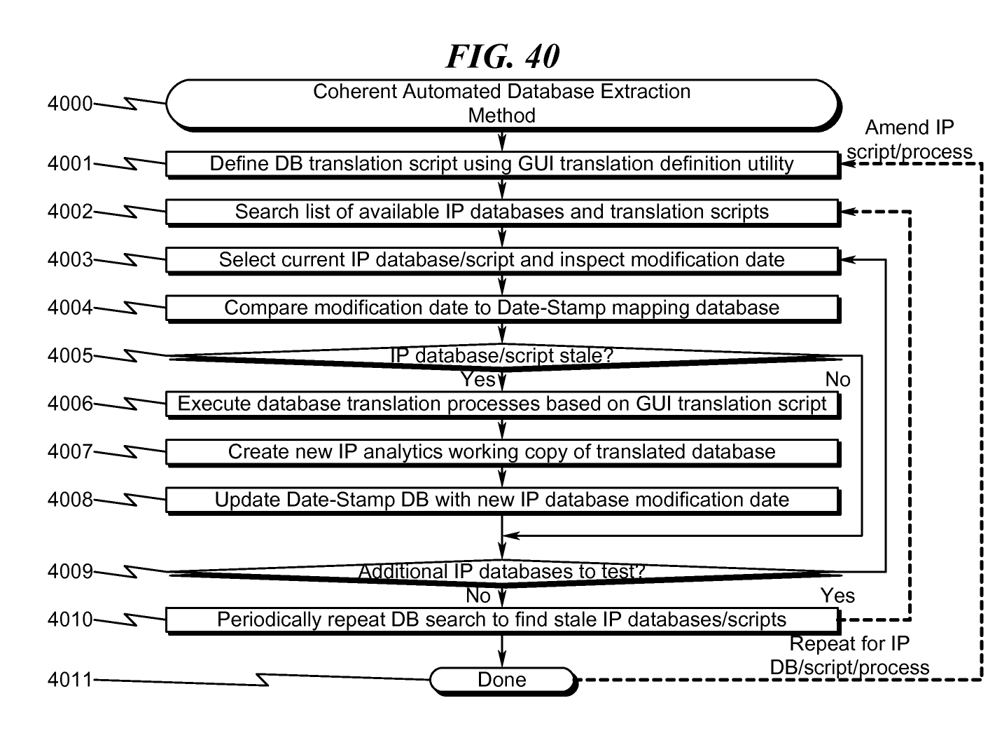

The automated database extraction system described above may be utilized in the context of an overall automated database extraction method, wherein the automated database extraction system described previously is controlled by a method as depicted in FIG. 40 (4000) having the following steps:
(1) Defining a database translation scrip using a GUI network editor translation definition utility (4001);
(2) Searching a list of available IP databases and translation scripts (4002);
(3) Selecting a current IP database/script for potential operation and inspecting the modification date (4003);
(4) Comparing the modification date of the database/script to a date-stamp mapping database that correlates databases/scripts with historical modification date stamps (4004);
(5) Determining if the IP database/script is “stale” and requires retranslation/reexecution, and if not, proceeding to step (9) (4005);
(6) Executing selected database translation processes based on the associated GUI translation scripts as they apply to the associated source IP database (4006);
(7) Creating a new derived IP analytics working copy of the source IP database using the translation processes (4007);
(8) Updating the date-stamp database with the new IP source database/script modification date (4008);
(9) Determining if additional IP databases/scripts must be tested and if so, proceeding to step (3) (4009);
(10) Periodically repeating the database/script search to find databases/scripts/procedures that have changed and require recreation of associated derived IP databases and proceeding to step (2) for periodic coherency checks (4010); and
(11) Terminating the procedure or proceeding to step (1) to modify/amend script definitions (4011);

Integration of this and other preferred exemplary embodiment methods in conjunction with a variety of preferred exemplary embodiment systems described herein is anticipated by the overall scope of the present invention.

### Technology Mining

The data flows depicted in the figures also permit modification of these reports to perform technology mining with respect to patent applications that have gone abandoned for lack of prosecution, patents whose term has expired, or patents that have expired for failure to pay maintenance fees. This information can be valuable to particular companies who wish to exploit technology within particular art fields or classes/subclasses. Thus, periodic or data-driven reports providing information on these technologies that have been placed within the public domain is one anticipated embodiment and use of the present invention.

### Free-Form Search Techniques (4100)-(4200)

### Free-Form Input Overview

The present invention anticipates that some analytics queries from the user may occur in free-form format and may be guided by intelligence within the invention to allow unsophisticated users to generate summary reports in response to IP analytics queries that require information to be gathered from numerous disparate databases. For example, a query sequence may be guided as in the following example:
QUERY: oil patents
RESPONSE: oil/gas patents or just oil patents?
QUERY: oil rigs
RESPONSE: oil drilling rigs or drilling attachments?
QUERY: drill bits
RESPONSE: directional drilling or conventional drilling?
QUERY: refurbishing
RESPONSE: potential class is XXX/YYY for drill bit refurbishing—potential synonyms for drill bit grinding . . . .
QUERY: manufacturers
RESPONSE: assignees in this art group include: ACME drilling, . . . .

One skilled in the art will recognize that this example may be modified heavily by using the structure within the patent classification databases used by various patent authorities to guide the user based on technology or assignee affiliations. Note also that the use of synonyms and/or antonyms in this searching criterion may be used to assist the search process within the patent classifications.

### General Free-Form Search (4100)

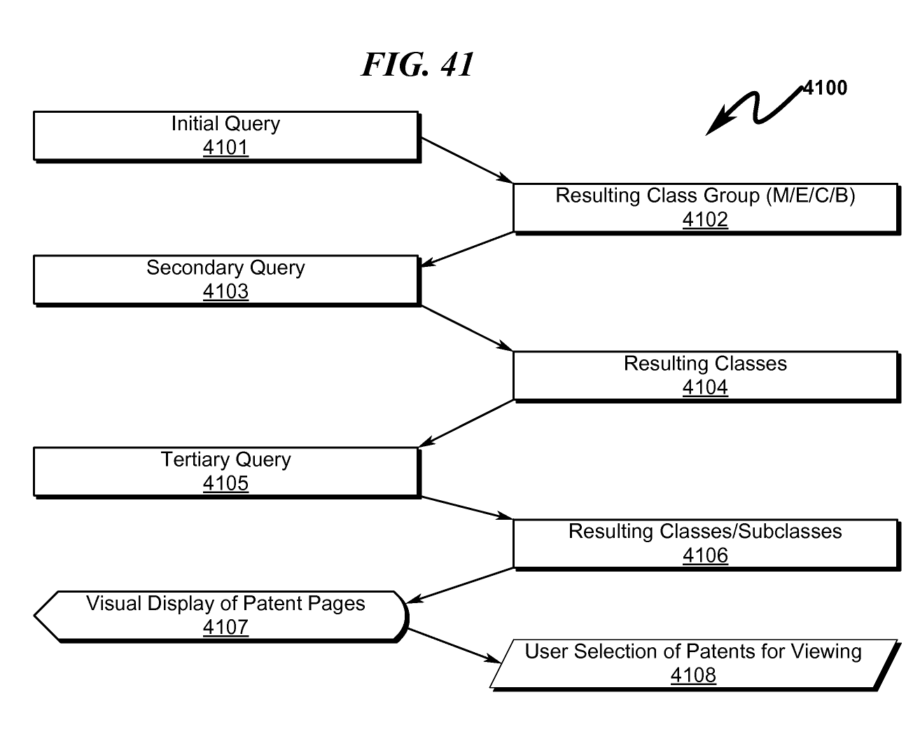

A general view of this hierarchical free-form searching technique is depicted in FIG. 41 (4100) wherein an initial user query (4101) results in the parallel display of major invention classes that are associated with the search term in the mechanical/electrical/chemical/biotech fields (4102). A secondary search term (4103) then dives within the classes within the major classes (4102) to generate a further defined list of classes (4104) that contain the search term. Further refinement using a tertiary query (4105) may result in the display of classes/subclasses (4106) containing the requested search terms. At some point the resulting search will be sufficiently defined to generate a PDF multi-tabbed display (4107) of patent front pages (or drawing pages) associated with the search query that may be then selected by the user (4108) for individual display/printing.

### Synonym/Antonym/Patent Classification Search Assistance (4200)

Often a search criterion within a given IP query may involve a number of terms that are used synonymously within a particular industry or art field. While the use of regular wildcard expressions can to some degree reduce the incidence of missed searches within a given IP query, this will never provide the degree of accuracy required of a formal IP query. The present invention addresses this deficiency by linking IP query text provided by the user (in a user search dialog input box) to a synonym dictionary of related terms or links to patent classification (or other IP related) databases that include terminology that may be related to the user IP query.

These links may be displayed on a viewing window within the main query display and provide the user the option of selecting additional matching criterion for a given query. For example, matches to the patent classification database may permit selection of classes/subclasses for inclusion in the query. Inclusion of text fields within a synonym (or antonym) dictionary may trigger additional suggestions from the patent classification index.

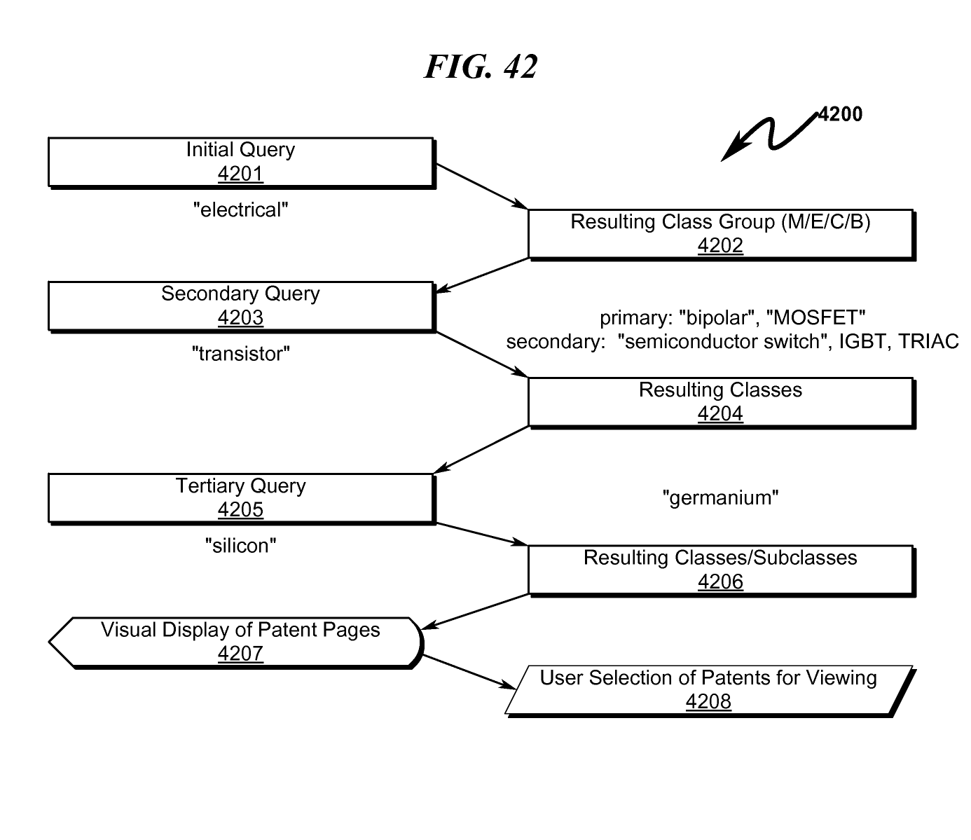

As depicted in the exemplary query entry/responses in FIG. 42 (4200), this synonym/antonym suggestion process can aid the search process by cross-linking related terms specific to the field of art being searched so as to better inform the user of potential keywords that are related to the search area of interest. Note in this example that as the user enters information on the left side of the page in a dialog entry, corresponding synonym/antonym terms and related information is dynamically displayed on the right side of the display. This information in conjunction with the class/subclass descriptions that are displayed in the response dialogs (4202, 4204, 4206) provide real-time feedback during the search process by the user and help hone the scope of search.

As detailed below, one aspect of this type of search methodology is the use of custom class/subclass patent dictionaries that are created by the present invention for use in generating the search term synonym/antonym suggestions within these dialog screens. These specialized dictionaries permit the context of the search to be localized to the art area in question and also permit the user to gain knowledge of related terms in the art that may not be familiar or identical to the terms being searched. This solves a common problem in patent searching as terms that may be related are not necessarily given the same name in patent literature. The process by which these class/subclass patent dictionaries are generated is described below.

### Technology-Directed Terminology Dictionaries (4300)-(4400)

### Automated Patent Dictionary Extraction System (4300)

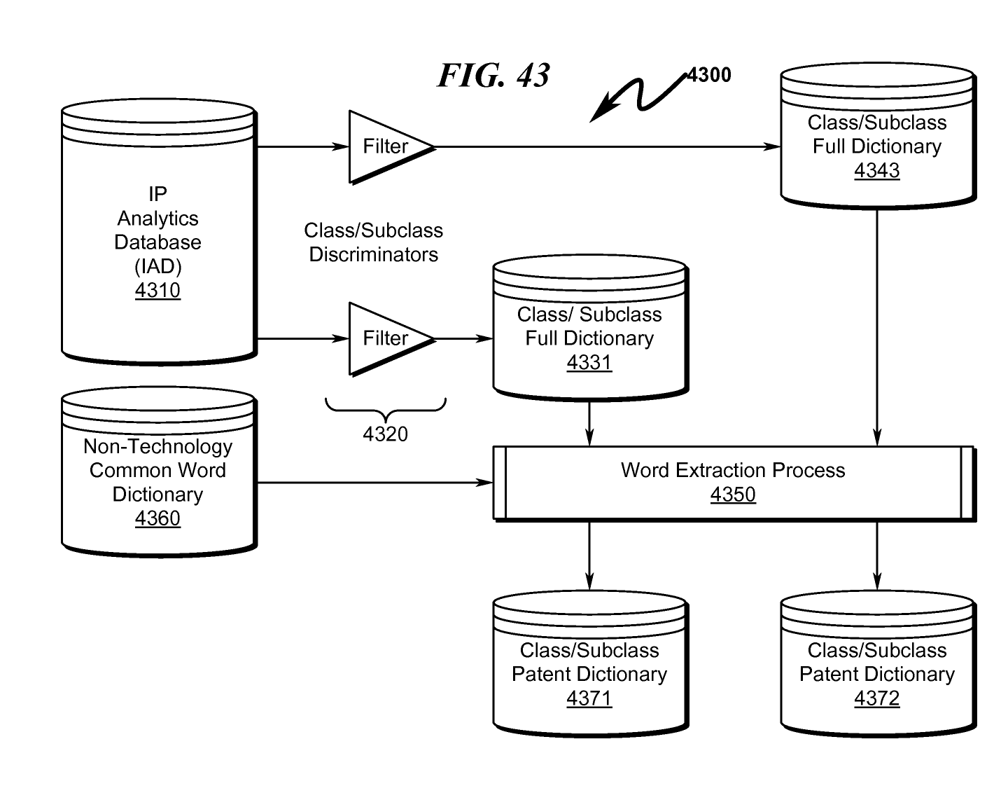

The present invention anticipates that within each class/subclass or technology area there may be an associated dictionary that is generated to aid in the searching process and provide the basis for synonym/antonym and related term searching within a given technology area. This may be accomplished as indicated in FIG. 43 (4300) wherein the IP analytics database (IAD) (4310) is run through a variety of class/subclass specific filters (4320) that extract all words from patents with a given class/subclass (or technology area). This word list is stored in class/subclass full dictionaries (4331, 4341) and then processed by a word extraction process (4350) that uses a non-technology common word dictionary (4360) to remove words that are non-technology specific (“a”, “the”, “first”, “only”, etc.). The results of this word extraction process (4350) are individual class/subclass patent dictionaries (4371, 4372) that are specific to each class/subclass or technology area. These individual class/subclass patent dictionaries (4371, 4372) may then form the basis of assisted IAN searches within a particular technology area.

### Automated Patent Dictionary Extraction Method (4400)

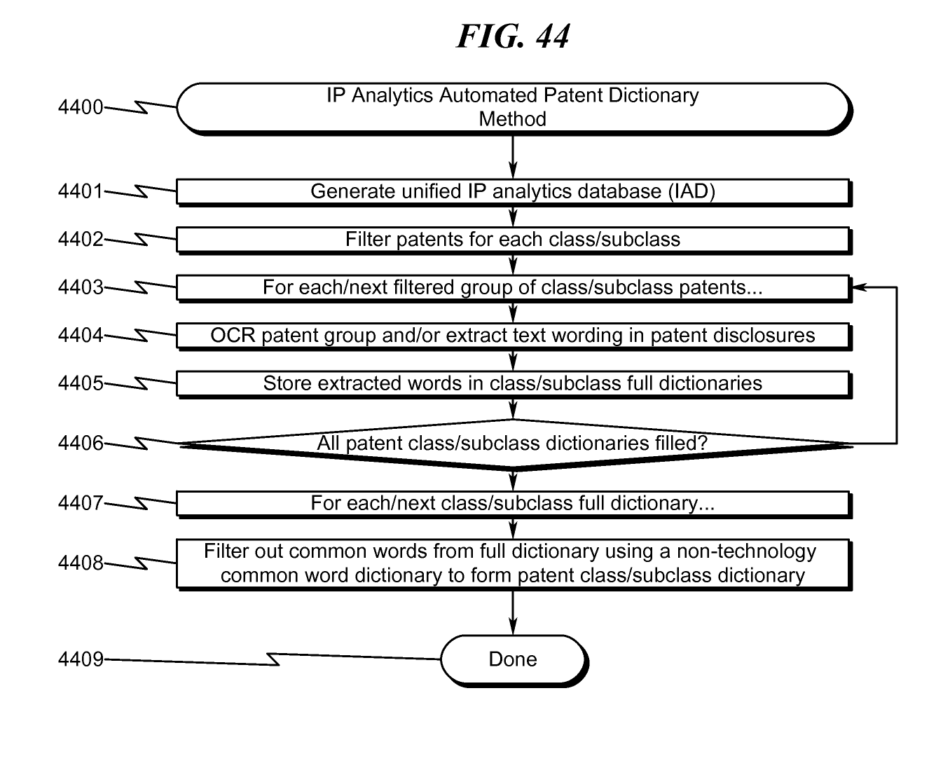

The automated patent dictionary extraction system described above may be utilized in the context of an overall automated patent dictionary extraction method, wherein the automated dictionary extraction system described previously is controlled by a method as depicted in FIG. 44 (4400) having the following steps:
(1) Generating a unified IP analytics database (IAD) (4401);
(2) Filtering to generate patent groups from the IAD for each class/subclass (4402);
(3) For each/next filtered group of class/subclass patents perform the following steps . . . (4403);
(4) OCR the patent group and/or extract text wording in the patent disclosures (text/drawings) (4404);
(5) Storing extracted words from each patent in the class/subclass group in an individual class/subclass full dictionary (4405);
(6) Determining if all patent class/subclass dictionaries have been created/filled, and if not, proceeding to step (3) (4406);
(7) For each/next class/subclass full dictionary that has been created, creating a patent dictionary (4407); and
(8) Filtering out common words from each full dictionary using a non-technology common word dictionary to form the content of an individual patent class/subclass dictionary (4408).

Integration of this and other preferred exemplary embodiment methods in conjunction with a variety of preferred exemplary embodiment systems described herein is anticipated by the overall scope of the present invention. It is significant to note that as new art appears in the IAD, nomenclature associated with this art will automatically be incorporated into the technology class/subclass dictionary that may be used as the basis for IAN searching.

### Historical Patent Classification Linking

The present invention anticipates that in some embodiments the patent classification system may change over time and thus the system may incorporate historical links to other patent classification datasets (other than the currently applicable patent classification list) in order to properly cross reference a given patent classification to all historically relevant data associated with a given query. As patent classifications and other information associated with original patent databases changes, this information can be used to cross-link against historical patent database information to ensure that historical links are preserved in light of updated patent database datum keys/indexes.

### Pre-Indexed File Search Datasets

The present invention anticipates that any dataset associated with the present invention having keyed field access may be pre-indexed and provided as an associated dataset within the overall context of the IPD search. For example, patent numbers associated with specific patent classes/subclasses may be pre-searched and provided in an ancillary IPD dataset to speed search times. This pre-indexing feature may be combined with periodic automated database coherency checks as depicted in FIG. 39 (3900) and FIG. 40 (4000) to ensure that these derived databases are maintained in a consistent and coherent state.

### Context-Sensitive Queries

Once a particular report has been generated, the context of the report may contain a variety of information that may then be used as a starting point for other analysis functions within the present invention. The graphical user interface (GUI) network editor depicted in FIG. 4 (0400) may be augmented with a copy/paste/drag/drop interface that allows the results of a given analytics operation to be used as the starting point for more sophisticated analysis. This copy/paste/drag/drop interface may comprise the capability to use the DATA COLLECTED as a starting point or the ANALYSIS FLOW as a starting point for further analysis. The difference between these two concepts is that the DATA COLLECTED is statically collected at a given point in time, whereas the ANALYSIS FLOW constitutes the network tree of processes used to create the DATA COLLECTED and may be reexecuted at a later date with updated source information to generate a new report or other dataset. Thus the ANALYSIS FLOW may represent processes and procedures that may be linked in very complex strings to produce periodic or event-triggered analysis functions.

### Search Results Display (4500)-(4600)

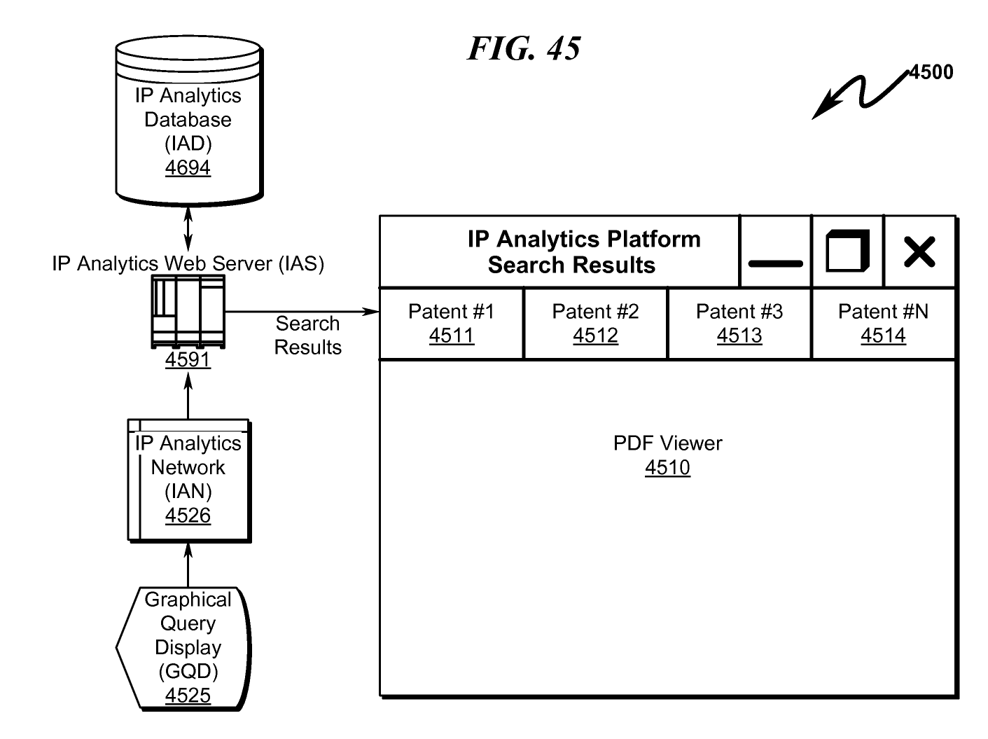

A useful feature of the present invention is that when patent search or other results are generated they are presented in forms that are useful for both viewing and for integrating into other document platforms for the generation of reports and the like. An example of this is presented in FIG. 45 (4500) wherein the IAS (4591) has interpreted an IAN (4526) generated by the GQD (4525) to extract information from the IAD (4594) and generate a search report. This report is displayed in a PDF viewer (4501) that presents a number of tabs (4511, 4512, 4513, 4514) corresponding to the patents or other documents that have been retrieved as a result of the IAN (4526) interpretation. This display format is significantly different that that provided by other patent search engines because the results are fully loaded within the PDF viewer in tabbed format to enable rapid viewing of each resultant document.

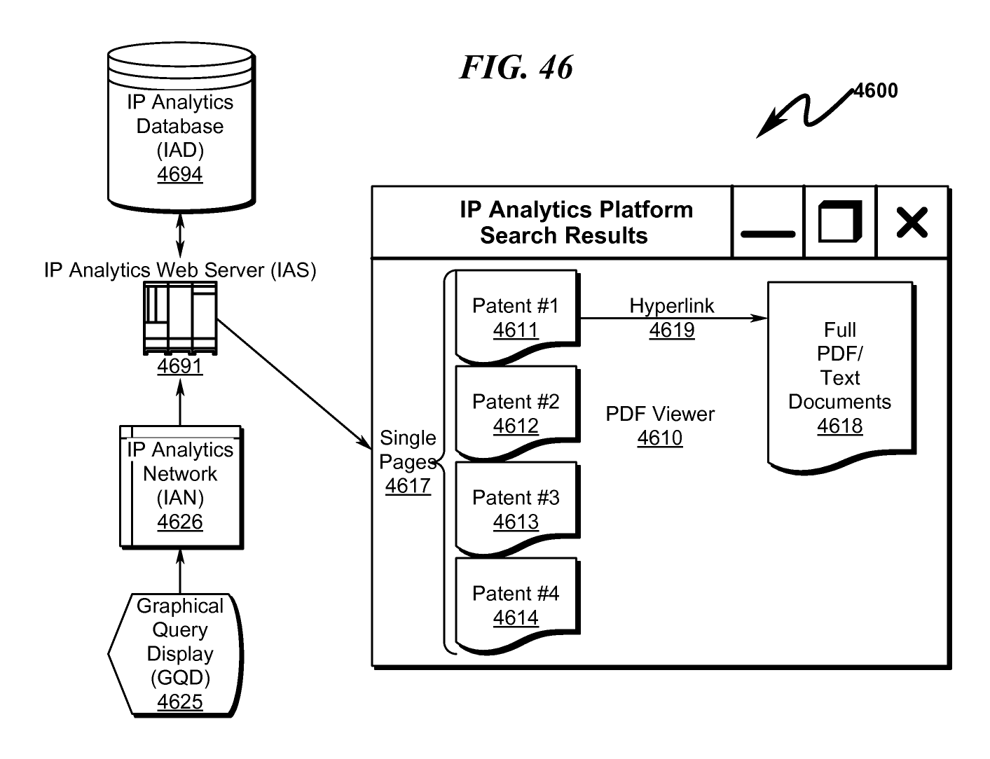

Alternatively, as depicted in FIG. 46 (4600), a search result summary document can be generated that incorporates the first index pages (4617) of each resulting patent/document (4611, 4612, 4613, 4614), and the individual patent documents (4618) may be accessed via these hyperlinks (4619) within this singular container document. These hyperlinks (4619) may reference documentation hosted by the IAS (4691) and thus permit the container file (4610) to be relatively small and portable for transmission using e-mail and other communication services that may include mobile wireless devices and the like.

### Image/Text Hypertext Integration (4700)-(4800)

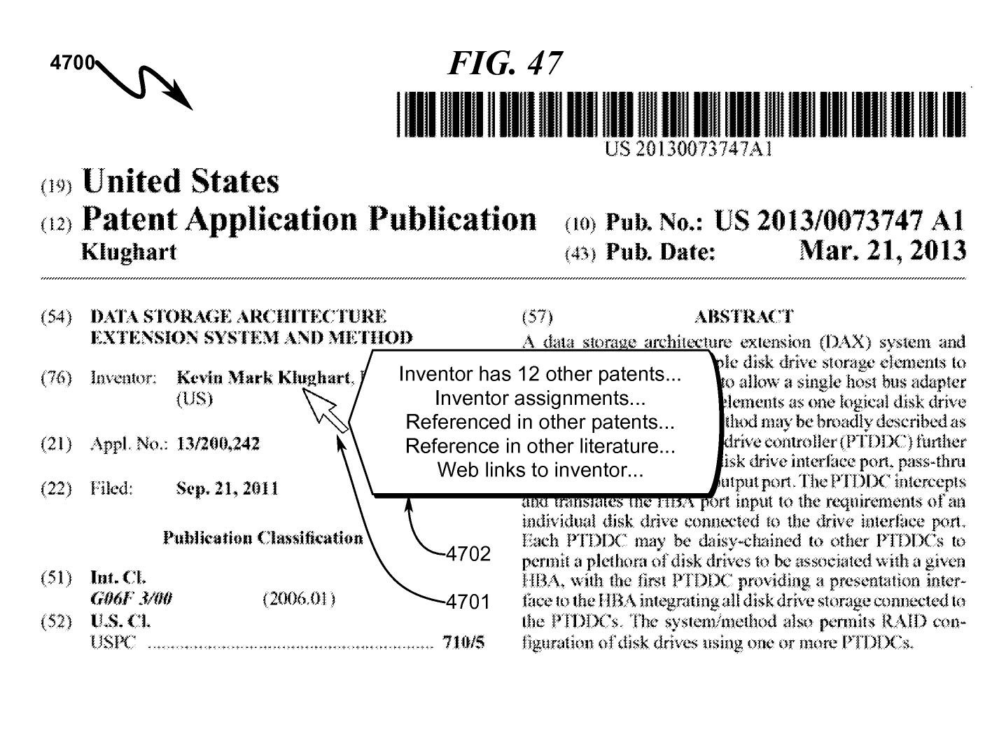

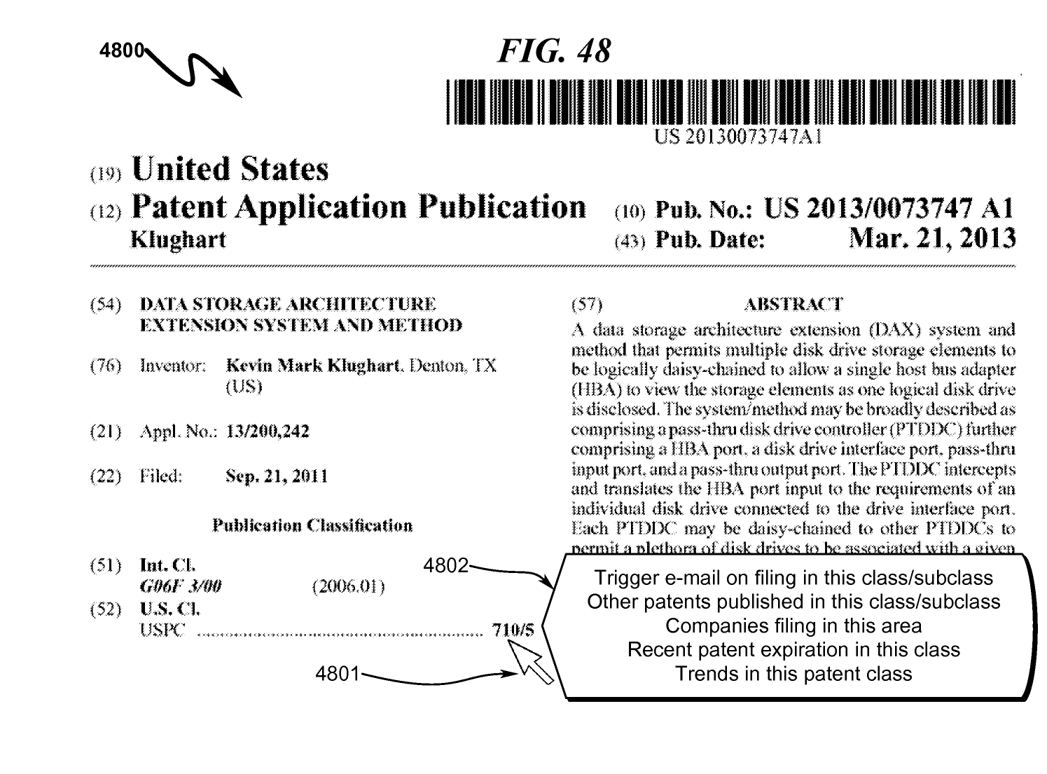

The IAD as described herein contains a plethora of interlinked data objects associated with the IP analytics function and this integrated information is made available in hyperlinked form when presented to the user in the form of resulting documents and images. Examples of this are depicted in FIG. 47 (4700) and FIG. 48 (4800).

As illustrated in FIG. 47 (4700), upon display of any image or text associated with a resulting document, placement of the cursor (4701) over a given field displays options associated with cross-links to that particular field (4702) that may be displayed on separate screens by selecting the cross-linked data item within the option dialog (4702). As illustrated in FIG. 48 (4800), this cursor (4801) placement technique may elicit options (4802) that include traversing a wide range of search and reporting options including other classes/subclasses as well as information regarding documents not directly tied to the original patent database.

It should be noted that these hyperlink search options (4702, 4802) may constitute predefined template search or analysis functions (0414) as depicted in FIG. 4 (0400). Thus, as the GQD generates an IAN, this IAN may form a primitive that can be linked to a search result (as a user-defined intermediate data result) and tagged to hyperlinked fields in a displayed document for the purposes of augmenting the fields within the document with predefined analysis functions that cross IAD database boundaries.

### IP Query Billing

The present invention anticipates that some embodiments of the present invention may incorporate a pay-per-service billing component configured to automatically bill customers for their use of the IP analytics capabilities of the system. This may include electronic financial transactions (electronic funds transfers (EFTs), credit card transactions, etc.) associated with individual IP queries, access to specific databases, the use of predefined IP analysis query templates, notification via periodic reports, and/or notification based on updates to IPD datasets.

### Preferred Embodiment System Summary

The present invention preferred exemplary system embodiment anticipates a wide variety of variations in the basic theme of construction, but can be generalized as an Intellectual Property (IP) Analytics system comprising:
(a) IP Analytics Web Server (IAS);
(b) IP Analytics Database (IAD); and
(c) IP Analytics User Interface (IAU);

wherein
the IAS is configured to communicate with the IAU over the Internet;
the IAU is configured to present a graphical user interface (GUI) hosted by the IAS;
the GUI hosting by the IAS comprises machine instructions executed by the IAS and read from a computer readable medium by the IAS;
the GUI presentation by the IAU comprises machine instructions executed by the IAU and read from a computer readable medium by the IAU;
the GUI is configured to present a menu interface to a user interacting with the IAU;
the menu interface comprises an editing tool configured to graphically arrange icons in an interconnected IP analysis network (IAN) representing IP data sources (IPD), IP processing functions (IPF), and IP report generation processes (IPR) under direction of the user;
the IAN is interpreted by the IAS to trigger access to the IAD to apply the IPF to data retrieved from the IAD as directed by data flows in the IAN; and
the IAN interpretation results in IP data that is processed by the IPR and displayed on the GUI.

This general system summary may be augmented by the various elements described herein to produce a wide variety of invention embodiments consistent with this overall design description.

### Preferred Embodiment Method Summary

The present invention preferred exemplary method embodiment anticipates a wide variety of variations in the basic theme of implementation, but can be generalized as an Intellectual Property (IP) Analytics method comprising:
(1) Graphically defining a connected IP analysis network (IAN) of IP data sources (IPD), IP analysis functions (IPF), and IP report generation processes (IPR) using a graphical user interface (GUI) operating under control of IP Analytics User Interface configured on a computer system executing instructions read from a computer readable medium;
(2) Transmitting the IAN over the Internet to an IP analytics web server (IAS) configured to implement a website on a computer system executing instructions read from a computer readable medium;
(3) Validating the IAN by the IAS to ensure that the IAN is a properly configured network graph;
(4) Triggering IPD data collection by the IAS from one or more IP analytics databases (IAD);
(5) Generating intermediate IPF datasets based on execution of the IAN network by the IAS;
(6) Processing IPR report requests by the IAS; and
(7) Displaying results of the IPR processing on the GUI, with optional interactive looping to step (1).
   One skilled in the art will recognize that these method steps may be augmented or rearranged without limiting the teachings of the present invention. This general method summary may be augmented by the various elements described herein to produce a wide variety of invention embodiments consistent with this overall design description.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the GUI further comprises an IP analysis template comprising a predefined IAN selected from a group consisting of: patent search; patent validity; patent freedom to operate; patent prosecution; patent litigation; technology trend; competitive analysis; and competitive alert.
An embodiment wherein the IPD comprises a database selected from a group consisting of: issued patent images; issued patent image OCR data; issued patent text; patent application images; patent application image OCR data; patent application text; USPTO Official Gazette images; USPTO Official Gazette image OCR data; Official Gazette text; Federal Register images; Federal Register image OCR data; Federal Register text; USPTO public Patent Application Information Retrieval (PAIR) images; USPTO public Patent Application Information Retrieval (PAIR) image OCR data; USPTO public Patent Application Information Retrieval (PAIR) text; USPTO private Patent Application Information Retrieval (PAIR) images; USPTO private Patent Application Information Retrieval (PAIR) image OCR data; USPTO private Patent Application Information Retrieval (PAIR) text; patent assignment data; patent maintenance fee data; patent classification data; patent petition decisions; and foreign patent publications.
An embodiment wherein the GUI comprises a high level data entry user interface that collects user data inputs to the IAN from a user located at the IAU.
An embodiment wherein the IPF comprises a function selected from a group consisting of: filtering functions; unitary BOOLEAN functions; binary BOOLEAN functions; pattern matching functions; numeric comparison functions; patent class context matching functions; keyed searching functions; and text compare functions.
An embodiment wherein the IPF comprises a patent class context matching function having parameters selected from a group consisting of: patent classification; patent assignee; patent inventor; patent search field; title text matching function; specification text matching function; and drawing text matching function.
An embodiment wherein the IPF comprises a text matching function selected from a group consisting of: wildcard regular expression; dictionary-driven synonym lookup; and classification text index lookup.
An embodiment wherein the IAS is configured to periodically inspect patent office websites for patent information not contained in the IAD and store the patent information in the IAD.
An embodiment wherein the IAS is configured to periodically inspect third party websites for patent information not contained in the IAD and store the patent information in the IAD.
An embodiment wherein the IAS is configured to periodically inspect third party websites for prior art data not contained in the IAD and store the prior art data in the IAD.
An embodiment wherein the IPF comprises a periodic function configured to trigger evaluation of the IAN at specific time intervals.
An embodiment wherein the IPF comprises an asynchronous execution function configured to trigger evaluation of the IAN when changes in the IAD are detected.
An embodiment wherein the IPF comprises a keyed search function having an index selected from a group consisting of: All Fields; Abstract; Applicant Name; Applicant City; Applicant State; Applicant Country; Applicant Type; Application Date; Application Serial Number; Application Type; Art Unit; Assignee Name; Assignee City; Assignee State; Assignee Country; Attorney or Agent; Claim(s); Classification—Current CPC; Classification—Past CPC; Classification—Current US; Classification—Past US; Classification—International; Examiner—Supervising; Examiner—Primary; Examiner—Assistant; Firm; Foreign Priority; Foreign References; Government Interest; Inventor Name; Inventor City; Inventor State; Inventor Country; Inventor Citizenship; Issue Date; Other References; Patent Family ID; Patent Number; PCT Information; PCT 371(c)/124 Date; PCT Filing Date; Priority Claims Date; Prior Published Document Date; Referenced By; Reissue Data; Reissued Patent Application Filing Date; Related U.S. Application Data; Related Application Filing Date; Specification/Description; and Title.
An embodiment wherein the IAD comprises a pre-indexed dataset sorted by a key selected from a group consisting of: Abstract; Applicant Name; Applicant City; Applicant State; Applicant Country; Applicant Type; Application Date; Application Serial Number; Application Type; Art Unit; Assignee Name; Assignee City; Assignee State; Assignee Country; Attorney or Agent; Claim(s); Classification—Current CPC; Classification—Past CPC; Classification—Current US; Classification—Past US; Classification—International; Examiner—Supervising; Examiner—Primary; Examiner—Assistant; Firm; Foreign Priority; Foreign References; Government Interest; Inventor Name; Inventor City; Inventor State; Inventor Country; Inventor Citizenship; Issue Date; Other References; Patent Family ID; Patent Number; PCT Information; PCT 371(c)/124 Date; PCT Filing Date; Priority Claims Date; Prior Published Document Date; Referenced By; Reissue Data; Reissued Patent Application Filing Date; Related U.S. Application Data; Related Application Filing Date; Specification/Description; and Title.
An embodiment wherein the IPD comprises a database selected from a group consisting of: trademark registration images; trademark application text; trademark assignment text; trademark trial and appeal board text; and trademark application images.
An embodiment wherein the GUI further comprises a query search input dialog box that is configured to display search query assistance dynamically derived from a synonym dictionary upon detection of input from the user.
An embodiment wherein the GUI further comprises a query search input dialog box that is configured to display search query assistance dynamically derived from an antonym dictionary upon detection of input from the user.
An embodiment wherein the GUI further comprises a query search input dialog box that is configured to display search query assistance dynamically derived from a patent classification dictionary upon detection of input from the user.
An embodiment wherein the IAS is configured to interpret the IAN by fracturing data paths within the IAN into a number of separate data paths and then asynchronously executing evaluation of the separate data paths until all the separate data paths have been interpreted.
An embodiment wherein the IAS is configured to execute an electronic financial transaction associated with the interpretation of the IAN.
An embodiment wherein the IAN is configured to execute a patent search analysis and generate a subsequent report by accessing patent office databases to inspect classes, issued patents, and patent application data related to a user search query and filter the related data based on class/subclass information and text search criterion provided by the user.
An embodiment wherein the IAN is configured to execute a patent validity analysis and generate a subsequent report by accessing patent office databases to inspect classes, issued patents, and patent application data related to a user patent query and filter the related data based on class/subclass information and text search criterion provided by the user.
An embodiment wherein the IAN is configured to execute a provisional patent priority analysis and generate a subsequent report by accessing patent office databases to retrieve provisional patent applications (PPAs) associated with a subsequently filed utility patent application and produce a list of differences between the PPAs.
An embodiment wherein the IAN is configured to execute a patent prosecution analysis and generate template documents for a subsequent office action response (OAR) by transforming information associated with a patent office communication into a document file that incorporates hyperlinks to prior art references made within the patent office communication and launching a document editor to permit user additions to the OAR.
An embodiment wherein the IAN is configured to execute a patent art group/examiner analysis and generate a report on a particular patent art group or patent examiner comprising statistics selected from a group consisting of: allowance statistics; rejection statistics; RCE statistics; patent pendency; and patent backlog.
An embodiment wherein the IAN is configured to execute a litigation search analysis evaluating prior art associated with a particular issued patent and generate a report detailing prior art associated with the class/subclass for the issued patent and file wrapper history information concerning claims rejections citing the prior art.
An embodiment wherein the IAN is configured to execute a patent/portfolio analysis that determines the influence of a selected patent/portfolio by determining references made to the patent/portfolio in patent file wrappers and issued patents and the context in which these references are made.
An embodiment wherein the IAS is configured to execute a periodic update monitoring process that determines if the IPD has been updated by comparing the file modification dates of the IPD to a date-stamp mapping database and if the IPD has been detected as updated, executing a translation script that triggers one or more translation processes to create a newly derived IP IPD analytics database from the IPD for use by the IAN.
An embodiment wherein the IAS is configured to execute a periodic update monitoring process that determines if translation processes associated with the IPD have been updated by comparing the file modification dates of the translation processes to a date-stamp mapping database and if the translation processes have been detected as updated, executing a translation script that triggers application of the translation processes to create a newly derived IP IPD analytics database from the IPD for use by the IAN.
An embodiment wherein the IAS is configured to execute a periodic update monitoring process that determines if translation scripts associated with the IPD have been updated by comparing the file modification dates of the translation scripts to a date-stamp mapping database and if the translation scripts have been detected as updated, executing the translation scripts to trigger application of translation processes to create a newly derived IP IPD analytics database from the IPD for use by the IAN.

One skilled in the art will recognize that other embodiments are possible based on combinations of elements taught within the above invention description. As indicated above, these invention variations are applicable to the system, method, and computer readable media embodiments of the invention.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

An Intellectual Property (IP) Analytics system/method supporting the rapid analysis of data associated with patents, copyrights, and/or trademarks has been disclosed. The system incorporates a graphical user interface (GUI) in conjunction with an IP analytics web server (IAS) to permit user queries regarding IP information to be defined as a graphically interconnected network (GIN) of information flows connecting defined IP data sources, processing functions, and report generation modules. The GIN may be arbitrarily configured based on IP query context to optimize retrieval of information associated with tasks commonly performed in support of IP procurement, maintenance, and defense operations. The system permits a variety of IP query application contexts to be supported, including prosecution, litigation, valuation, licensing, competitive analysis, and commercial research/development. Support for synchronous and asynchronous data analysis is supported with provisions for application programming interfaces (APIs) to IP databases not maintained by the IAS.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

Within the context of the following CLAIMS, the CLAIM PREAMBLE should be considered as limiting the scope of the claimed invention. Within the context of the following CLAIMS, “wherein” clauses should be considered as limiting the scope of the claimed invention.

What is claimed is:

1. A Intellectual Property (IP) Analytics system comprising:
(a) IP Analytics Web Server (IAS);
(b) IP Analytics Database (IAD); and
(c) IP Analytics User Interface (IAU);
wherein
said IAS is configured to communicate with said IAU over the Internet;
said IAU is configured to present a graphical user interface (GUI) hosted by said IAS;
said GUI hosting by said IAS comprises machine instructions executed by said IAS and read from a computer readable medium by said IAS;
said GUI presentation by said IAU comprises machine instructions executed by said IAU and read from a computer readable medium by said IAU;
said GUI is configured to present a menu interface to a user interacting with said IAU;
said menu interface comprises an editing tool configured to graphically arrange icons in an interconnected IP analysis network (IAN) representing IP data sources (IPD), IP processing functions (IPF), and IP report generation processes (IPR) under direction of said user;
said IAN is interpreted by said IAS to trigger access to said IAD to apply said IPF to data retrieved from said IAD as directed by data flows in said IAN; and
said IAN interpretation results in IP data that is processed by said IPR and displayed on said GUI.

2. The Intellectual Property (IP) Analytics system of claim 1 wherein said GUI further comprises an IP analysis template comprising a predefined IAN selected from a group consisting of: patent search; patent validity; patent freedom to operate; patent prosecution; patent litigation; technology trend; competitive analysis; and competitive alert.

3. The Intellectual Property (IP) Analytics system of claim 1 wherein said IPD comprises a database selected from a group consisting of: issued patent images; issued patent image OCR data; issued patent text; patent application images; patent application image OCR data; patent application text; USPTO Official Gazette images; USPTO Official Gazette image OCR data; Official Gazette text; Federal Register images; Federal Register image OCR data; Federal Register text; USPTO public Patent Application Information Retrieval (PAIR) images; USPTO public Patent Application Information Retrieval (PAIR) image OCR data; USPTO public Patent Application Information Retrieval (PAIR) text; USPTO private Patent Application Information Retrieval (PAIR) images; USPTO private Patent Application Information Retrieval (PAIR) image OCR data; USPTO private Patent Application Information Retrieval (PAIR) text; patent assignment data; patent maintenance fee data; patent classification data; patent petition decisions; and foreign patent publications.

4. The Intellectual Property (IP) Analytics system of claim 1 wherein said GUI comprises a high level data entry user interface that collects user data inputs to said IAN from a user located at said IAU.

5. The Intellectual Property (IP) Analytics system of claim 1 wherein said IPF comprises a function selected from a group consisting of: filtering functions; unitary BOOLEAN functions; binary BOOLEAN functions; pattern matching functions; numeric comparison functions; patent class context matching functions; keyed searching functions; and text compare functions.

6. The Intellectual Property (IP) Analytics system of claim 1 wherein said IPF comprises a patent class context matching function having parameters selected from a group consisting of: patent classification; patent assignee; patent inventor; patent search field; title text matching function; specification text matching function; and drawing text matching function.

7. The Intellectual Property (IP) Analytics system of claim 1 wherein said IPF comprises a text matching function selected from a group consisting of: wildcard regular expression; dictionary-driven synonym lookup; and classification text index lookup.

8. The Intellectual Property (IP) Analytics system of claim 1 wherein said IAS is configured to periodically inspect patent office websites for patent information not contained in said IAD and store said patent information in said IAD.

9. The Intellectual Property (IP) Analytics system of claim 1 wherein said IAS is configured to periodically inspect third party websites for patent information not contained in said IAD and store said patent information in said IAD.

10. The Intellectual Property (IP) Analytics system of claim 1 wherein said IAS is configured to periodically inspect third party websites for prior art data not contained in said IAD and store said prior art data in said IAD.

11. The Intellectual Property (IP) Analytics system of claim 1 wherein said IPF comprises a periodic function configured to trigger evaluation of said IAN at specific time intervals.

12. The Intellectual Property (IP) Analytics system of claim 1 wherein said IPF comprises an asynchronous execution function configured to trigger evaluation of said IAN when changes in said IAD are detected.

13. The Intellectual Property (IP) Analytics system of claim 1 wherein said IPF comprises a keyed search function having an index selected from a group consisting of: All Fields; Abstract; Applicant Name; Applicant City; Applicant State; Applicant Country; Applicant Type; Application Date; Application Serial Number; Application Type; Art Unit; Assignee Name; Assignee City; Assignee State; Assignee Country; Attorney or Agent; claim(s); Classification—Current CPC; Classification—Past CPC; Classification—Current US; Classification—Past US; Classification—International; Examiner—Supervising; Examiner—Primary; Examiner—Assistant; Firm; Foreign Priority; Foreign References; Government Interest; Inventor Name; Inventor City; Inventor State; Inventor Country; Inventor Citizenship; Issue Date; Other References; Patent Family ID; Patent Number; PCT Information; PCT 371(c)/124 Date; PCT Filing Date; Priority claims Date; Prior Published Document Date; Referenced By; Reissue Data; Reissued Patent Application Filing Date; Related U.S. Application Data; Related Application Filing Date; Specification/Description; and Title.

14. The Intellectual Property (IP) Analytics system of claim 1 wherein said IAD comprises a pre-indexed dataset sorted by a key selected from a group consisting of: Abstract; Applicant Name; Applicant City; Applicant State; Applicant Country; Applicant Type; Application Date; Application Serial Number; Application Type; Art Unit; Assignee Name; Assignee City; Assignee State; Assignee Country; Attorney or Agent; claim(s); Classification—Current CPC; Classification—Past CPC; Classification—Current US; Classification—Past US; Classification—International; Examiner—Supervising; Examiner—Primary; Examiner—Assistant; Firm; Foreign Priority; Foreign References; Government Interest; Inventor Name; Inventor City; Inventor State; Inventor Country; Inventor Citizenship; Issue Date; Other References; Patent Family ID; Patent Number; PCT Information; PCT 371(c)/124 Date; PCT Filing Date; Priority claims Date; Prior Published Document Date; Referenced By; Reissue Data; Reissued Patent Application Filing Date; Related U.S. Application Data; Related Application Filing Date; Specification/Description; and Title.

15. The Intellectual Property (IP) Analytics system of claim 1 wherein said IPD comprises a database selected from a group consisting of: trademark registration images; trademark application text; trademark assignment text; trademark trial and appeal board text; and trademark application images.

16. The Intellectual Property (IP) Analytics system of claim 1 wherein said GUI further comprises a query search input dialog box that is configured to display search query assistance dynamically derived from a synonym dictionary upon detection of input from said user.

17. The Intellectual Property (IP) Analytics system of claim 1 wherein said GUI further comprises a query search input dialog box that is configured to display search query assistance dynamically derived from an antonym dictionary upon detection of input from said user.

18. The Intellectual Property (IP) Analytics system of claim 1 wherein said GUI further comprises a query search input dialog box that is configured to display search query assistance dynamically derived from a patent classification dictionary upon detection of input from said user.

19. The Intellectual Property (IP) Analytics system of claim 1 wherein said IAS is configured to interpret said IAN by fracturing data paths within said IAN into a number of separate data paths and then asynchronously executing evaluation of said separate data paths until all said separate data paths have been interpreted.

20. The Intellectual Property (IP) Analytics system of claim 1 wherein said IAS is configured to execute an electronic financial transaction associated with said interpretation of said IAN.

21. The Intellectual Property (IP) Analytics system of claim 1 wherein said IAN is configured to execute a patent search analysis and generate a subsequent report by accessing patent office databases to inspect classes, issued patents, and patent application data related to a user search query and filter said related data based on class/subclass information and text search criterion provided by said user.

22. The Intellectual Property (IP) Analytics system of claim 1 wherein said IAN is configured to execute a patent validity analysis and generate a subsequent report by accessing patent office databases to inspect classes, issued patents, and patent application data related to a user patent query and filter said related data based on class/subclass information and text search criterion provided by said user.

23. The Intellectual Property (IP) Analytics system of claim 1 wherein said IAN is configured to execute a provisional patent priority analysis and generate a subsequent report by accessing patent office databases to retrieve provisional patent applications (PPAs) associated with a subsequently filed utility patent application and produce a list of differences between said PPAs.

24. The Intellectual Property (IP) Analytics system of claim 1 wherein said IAN is configured to execute a patent prosecution analysis and generate template documents for a subsequent office action response (OAR) by transforming information associated with a patent office communication into a document file that incorporates hyperlinks to prior art references made within said patent office communication and launching a document editor to permit user additions to said OAR.

25. The Intellectual Property (IP) Analytics system of claim 1 wherein said IAN is configured to execute a patent art group/examiner analysis and generate a report on a particular patent art group or patent examiner comprising statistics selected from a group consisting of: allowance statistics; rejection statistics; RCE statistics; patent pendency; and patent backlog.

26. The Intellectual Property (IP) Analytics system of claim 1 wherein said IAN is configured to execute a litigation search analysis evaluating prior art associated with a particular issued patent and generate a report detailing prior art associated with the class/subclass for said issued patent and file wrapper history information concerning claims rejections citing said prior art.

27. The Intellectual Property (IP) Analytics system of claim 1 wherein said IAN is configured to execute a patent/portfolio analysis that determines the influence of a selected patent/portfolio by determining references made to said patent/portfolio in patent file wrappers and issued patents and the context in which these references are made.

28. The Intellectual Property (IP) Analytics system of claim 1 wherein said IAS is configured to execute a periodic update monitoring process that determines if said IPD has been updated by comparing the file modification dates of said IPD to a date-stamp mapping database and if said IPD has been detected as updated, executing a translation script that triggers one or more translation processes to create a newly derived IP IPD analytics database from said IPD for use by said IAN.

29. The Intellectual Property (IP) Analytics system of claim 1 wherein said IAS is configured to execute a periodic update monitoring process that determines if translation processes associated with said IPD have been updated by comparing the file modification dates of said translation processes to a date-stamp mapping database and if said translation processes have been detected as updated, executing a translation script that triggers application of said translation processes to create a newly derived IP IPD analytics database from said IPD for use by said IAN.

30. The Intellectual Property (IP) Analytics system of claim 1 wherein said IAS is configured to execute a periodic update monitoring process that determines if translation scripts associated with said IPD have been updated by comparing the file modification dates of said translation scripts to a date-stamp mapping database and if said translation scripts have been detected as updated, executing said translation scripts to trigger application of translation processes to create a newly derived IP IPD analytics database from said IPD for use by said IAN.

31. A Intellectual Property (IP) Analytics method comprising:
(1) Graphically defining a connected IP analysis network (IAN) of IP data sources (IPD), IP analysis functions (IPF), and IP report generation processes (IPR) using a graphical user interface (GUI) operating under control of IP Analytics User Interface configured on a computer system executing instructions read from a computer readable medium;
(2) Transmitting said IAN over the Internet to an IP analytics web server (IAS) configured to implement a website on a computer system executing instructions read from a computer readable medium;
(3) Validating said IAN by said IAS to ensure that said IAN is a properly configured network graph;
(4) Triggering IPD data collection by said IAS from one or more IP analytics databases (IAD);
(5) Generating intermediate IPF datasets based on execution of said IAN network by said IAS;
(6) Processing IPR report requests by said IAS; and
(7) Displaying results of said IPR processing on said GUI.

32. The Intellectual Property (IP) Analytics method of claim 31 wherein said GUI further comprises an IP analysis template comprising a predefined IAN selected from a group consisting of: patent search; patent validity; patent freedom to operate; patent prosecution; patent litigation; technology trend; competitive analysis; and competitive alert.

33. The Intellectual Property (IP) Analytics method of claim 31 wherein said IPD comprises a database selected from a group consisting of: issued patent images; issued patent image OCR data; issued patent text; patent application images; patent application image OCR data; patent application text; USPTO Official Gazette images; USPTO Official Gazette image OCR data; Official Gazette text; Federal Register images; Federal Register image OCR data; Federal Register text; USPTO public Patent Application Information Retrieval (PAIR) images; USPTO public Patent Application Information Retrieval (PAIR) image OCR data; USPTO public Patent Application Information Retrieval (PAIR) text; USPTO private Patent Application Information Retrieval (PAIR) images; USPTO private Patent Application Information Retrieval (PAIR) image OCR data; USPTO private Patent Application Information Retrieval (PAIR) text; patent assignment data; patent maintenance fee data; patent classification data; patent petition decisions; and foreign patent publications.

34. The Intellectual Property (IP) Analytics method of claim 31 wherein said GUI comprises a high level data entry user interface that collects user data inputs to said IAN from a user located at said IAU.

35. The Intellectual Property (IP) Analytics method of claim 31 wherein said IPF comprises a function selected from a group consisting of: filtering functions; unitary BOOLEAN functions; binary BOOLEAN functions; pattern matching functions; numeric comparison functions; patent class context matching functions; keyed searching functions; and text compare functions.

36. The Intellectual Property (IP) Analytics method of claim 31 wherein said IPF comprises a patent class context matching function having parameters selected from a group consisting of: patent classification; patent assignee; patent inventor; patent search field; title text matching function; specification text matching function; and drawing text matching function.

37. The Intellectual Property (IP) Analytics method of claim 31 wherein said IPF comprises a text matching function selected from a group consisting of: wildcard regular expression; dictionary-driven synonym lookup; and classification text index lookup.

38. The Intellectual Property (IP) Analytics method of claim 31 wherein said IAS is configured to periodically inspect patent office websites for patent information not contained in said IAD and store said patent information in said IAD.

39. The Intellectual Property (IP) Analytics method of claim 31 wherein said IAS is configured to periodically inspect third party websites for patent information not contained in said IAD and store said patent information in said IAD.

40. The Intellectual Property (IP) Analytics method of claim 31 wherein said IAS is configured to periodically inspect third party websites for prior art data not contained in said IAD and store said prior art data in said IAD.

41. The Intellectual Property (IP) Analytics method of claim 31 wherein said IPF comprises a periodic function configured to trigger evaluation of said IAN at specific time intervals.

42. The Intellectual Property (IP) Analytics method of claim 31 wherein said IPF comprises an asynchronous execution function configured to trigger evaluation of said IAN when changes in said IAD are detected.

43. The Intellectual Property (IP) Analytics method of claim 31 wherein said IPF comprises a keyed search function having an index selected from a group consisting of: All Fields; Abstract; Applicant Name; Applicant City; Applicant State; Applicant Country; Applicant Type; Application Date; Application Serial Number; Application Type; Art Unit; Assignee Name; Assignee City; Assignee State; Assignee Country; Attorney or Agent; claim(s); Classification—Current CPC; Classification—Past CPC; Classification—Current US; Classification—Past US; Classification—International; Examiner—Supervising; Examiner—Primary; Examiner—Assistant; Firm; Foreign Priority; Foreign References; Government Interest; Inventor Name; Inventor City; Inventor State; Inventor Country; Inventor Citizenship; Issue Date; Other References; Patent Family ID; Patent Number; PCT Information; PCT 371(c)/124 Date; PCT Filing Date; Priority claims Date; Prior Published Document Date; Referenced By; Reissue Data; Reissued Patent Application Filing Date; Related U.S. Application Data; Related Application Filing Date; Specification/Description; and Title.

44. The Intellectual Property (IP) Analytics method of claim 31 wherein said IAD comprises a pre-indexed dataset sorted by a key selected from a group consisting of: Abstract; Applicant Name; Applicant City; Applicant State; Applicant Country; Applicant Type; Application Date; Application Serial Number; Application Type; Art Unit; Assignee Name; Assignee City; Assignee State; Assignee Country; Attorney or Agent; claim(s); Classification—Current CPC; Classification—Past CPC; Classification—Current US; Classification—Past US; Classification—International; Examiner—Supervising; Examiner—Primary; Examiner—Assistant; Firm; Foreign Priority; Foreign References; Government Interest; Inventor Name; Inventor City; Inventor State; Inventor Country; Inventor Citizenship; Issue Date; Other References; Patent Family ID; Patent Number; PCT Information; PCT 371(c)/124 Date; PCT Filing Date; Priority claims Date; Prior Published Document Date; Referenced By; Reissue Data; Reissued Patent Application Filing Date; Related U.S. Application Data; Related Application Filing Date; Specification/Description; and Title.

45. The Intellectual Property (IP) Analytics method of claim 31 wherein said IPD comprises a database selected from a group consisting of: trademark registration images; trademark application text; trademark assignment text; trademark trial and appeal board text; and trademark application images.

46. The Intellectual Property (IP) Analytics method of claim 31 wherein said GUI further comprises a query search input dialog box that is configured to display search query assistance dynamically derived from a synonym dictionary upon detection of input from said user.

47. The Intellectual Property (IP) Analytics method of claim 31 wherein said GUI further comprises a query search input dialog box that is configured to display search query assistance dynamically derived from an antonym dictionary upon detection of input from said user.

48. The Intellectual Property (IP) Analytics method of claim 31 wherein said GUI further comprises a query search input dialog box that is configured to display search query assistance dynamically derived from a patent classification dictionary upon detection of input from said user.

49. The Intellectual Property (IP) Analytics method of claim 31 wherein said IAS is configured to interpret said IAN by fracturing data paths within said IAN into a number of separate data paths and then asynchronously executing evaluation of said separate data paths until all said separate data paths have been interpreted.

50. The Intellectual Property (IP) Analytics method of claim 31 wherein said IAS is configured to execute an electronic financial transaction associated with said interpretation of said IAN.

51. The Intellectual Property (IP) Analytics method of claim 31 wherein said IAN is configured to execute a patent search analysis and generate a subsequent report by accessing patent office databases to inspect classes, issued patents, and patent application data related to a user search query and filter said related data based on class/subclass information and text search criterion provided by said user.

52. The Intellectual Property (IP) Analytics method of claim 31 wherein said IAN is configured to execute a patent validity analysis and generate a subsequent report by accessing patent office databases to inspect classes, issued patents, and patent application data related to a user patent query and filter said related data based on class/subclass information and text search criterion provided by said user.

53. The Intellectual Property (IP) Analytics method of claim 31 wherein said IAN is configured to execute a provisional patent priority analysis and generate a subsequent report by accessing patent office databases to retrieve provisional patent applications (PPAs) associated with a subsequently filed utility patent application and produce a list of differences between said PPAs.

54. The Intellectual Property (IP) Analytics method of claim 31 wherein said IAN is configured to execute a patent prosecution analysis and generate template documents for a subsequent office action response (OAR) by transforming information associated with a patent office communication into a document file that incorporates hyperlinks to prior art references made within said patent office communication and launching a document editor to permit user additions to said OAR.

55. The Intellectual Property (IP) Analytics method of claim 31 wherein said IAN is configured to execute a patent art group/examiner analysis and generate a report on a particular patent art group or patent examiner comprising statistics selected from a group consisting of: allowance statistics; rejection statistics; RCE statistics; patent pendency; and patent backlog.

56. The Intellectual Property (IP) Analytics method of claim 31 wherein said IAN is configured to execute a litigation search analysis evaluating prior art associated with a particular issued patent and generate a report detailing prior art associated with the class/subclass for said issued patent and file wrapper history information concerning claims rejections citing said prior art.

57. The Intellectual Property (IP) Analytics method of claim 31 wherein said IAN is configured to execute a patent/portfolio analysis that determines the influence of a selected patent/portfolio by determining references made to said patent/portfolio in patent file wrappers and issued patents and the context in which these references are made.

58. The Intellectual Property (IP) Analytics method of claim 31 wherein said IAS is configured to execute a periodic update monitoring process that determines if said IPD has been updated by comparing the file modification dates of said IPD to a date-stamp mapping database and if said IPD has been detected as updated, executing a translation script that triggers one or more translation processes to create a newly derived IP IPD analytics database from said IPD for use by said IAN.

59. The Intellectual Property (IP) Analytics method of claim 31 wherein said IAS is configured to execute a periodic update monitoring process that determines if translation processes associated with said IPD have been updated by comparing the file modification dates of said translation processes to a date-stamp mapping database and if said translation processes have been detected as updated, executing a translation script that triggers application of said translation processes to create a newly derived IP IPD analytics database from said IPD for use by said IAN.

60. The Intellectual Property (IP) Analytics method of claim 31 wherein said IAS is configured to execute a periodic update monitoring process that determines if translation scripts associated with said IPD have been updated by comparing the file modification dates of said translation scripts to a date-stamp mapping database and if said translation scripts have been detected as updated, executing said translation scripts to trigger application of translation processes to create a newly derived IP IPD analytics database from said IPD for use by said IAN.
